(19) United States
(12) Patent Application Publication
(10) Pub. No.: US 2017/0233526 A1
(43) Pub. Date: Aug. 17, 2017

(54) PROCESS FOR THE PREPARATION OF POLYETHERCARBONATE POLYOLS

(71) Applicant: Covestro Deutschland AG, Leverkusen (DE)

(72) Inventors: Stefanie Braun, Köln (DE); Thomas Ernst Müller, Aachen (DE); Jörg Hofmann, Krefeld (DE); Kabir Rakibul, Aachen (DE); Walter Leitner, Aachen (DE); Muhammad Afzal Subhani, Aachen (DE)

(21) Appl. No.: 15/503,216

(22) PCT Filed: Aug. 10, 2015
(86) PCT No.: PCT/EP2015/068347

§ 371 Date: Feb. 10, 2017

(30) Foreign Application Priority Data
Aug. 11, 2014 (EP) 14180551.5
Aug. 13, 2014 (EP) 14180752.9

(51) Int. Cl. C08G 64/34

(52) U.S. Cl. CPC C08G 64/34

(57) ABSTRACT

A process for the preparation of polyethercarbonate polyols comprises the reaction of a reaction mixture comprising one or more H-functional starter compounds, one or more alkylene oxides, carbon dioxide and a double metal cyanide (DMC) catalyst. The reaction is conducted in a reactor under stirring with a specific power input into the reaction mixture, expressed as Watts per liter (W/L), of ≧0.07 to ≦5.00.

The present invention relates to a process for the preparation of polyethercarbonate polyols comprising the reaction of a reaction mixture comprising one or more H-functional starter compounds, one or more alkylene oxides, carbon dioxide and a double metal cyanide (DMC) catalyst.

The preparation of polyethercarbonate polyols by the catalytic reaction of alkylene oxides (epoxides) and carbon dioxide in the presence of H-functional starter substances (“starters”) has been studied intensively for more than 40 years (e.g. Inoue et al., Copolymerization of Carbon Dioxide and Epoxide with Organometallic Compounds; Die Makromolekulare Chemie 130, 210-220, 1969).

This reaction is shown schematically below, where R is an organic radical such as alkyl, alkylaryl or aryl, each of which can also contain heteroatoms such as O, S, Si, etc., and e and f are integers, and where the product shown here for the polyethercarbonate polyol is only to be understood as such that the indicated structure can in principle be found in the polyethercarbonate polyol obtained, but that the sequence, number and length of the blocks and the OH functionality of the starter can vary and are not limited to the polyethercarbonate polyol depicted. This reaction is ecologically very advantageous because it represents the conversion of a greenhouse gas like CO₂ to a polymer. The cyclic carbonate (e.g. propylene carbonate for R═CH₃) is formed as a further product (actually a by-product):

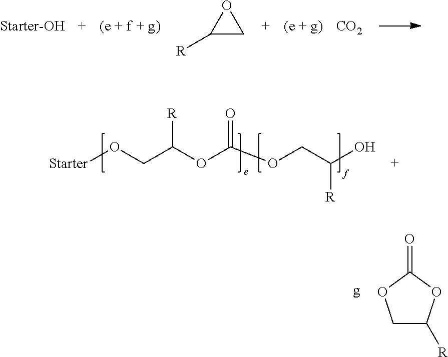

A general introduction into the subject may, for example, be found in EP 0 222 453 A1, which discloses a process for the preparation of a polyether carbonate, comprising the reaction of at least one epoxy compound and carbon dioxide at a temperature in the range of from 40 to 200° C. and at a pressure in the range of from 2 to 40 bar absolute, characterized in that the reaction is carried out in the presence of a catalytic amount of a double metal cyanide complex, and (a) one or more salts composed of at least bivalent metal ions and metal-free anions, having a solubility in water of at least 1 g/100 ml at 25° C., and/or (b) one or more no-metal containing acids of which a 0.1 N solution in water at 25° C. has a pH not exceeding 3.

As another example, WO 2013/011015 A1 discloses a method for producing polyether carbonate polyols from one or more H-functional starter compounds, one or more alkylene oxides, and carbon dioxide in the presence of a double metal cyanide catalyst. The method has the following steps: (α) the H-functional starter substances or a mixture of at least two H-functional starter substances are introduced; (β) a sub-quantity (with respect to the total quantity of the alkylene oxides used in the steps (β) and (γ)) of one or more alkylene oxides is added to the mixture resulting from step (a) for the purpose of activation, wherein the step (β) can also be carried out multiple times for the purpose of activation; and (γ) one or more alkylene oxides and carbon dioxide are continuously metered into the mixture resulting from step (β) (copolymerization), the alkylene oxides used for the copolymerization being the same or different from the alkylene oxides used in step (β). The invention is characterized in that the carbon dioxide is introduced into the mixture in step (γ) by (i) gassing the reaction mixture in the reactor from below, (ii) using a hollow shaft stiffer, (iii) combining the controlled deliveries according to (i) and (ii), and/or (iv) gassing over the liquid surface using multi-stage stirring elements.

Recently, the power intake of the reaction mixture from mechanical mixing devices such as stirrers and pumps has gained some attention. WO 2011/110484 A1, for instance, discloses a process for the catalytic preparation of polyetherols, wherein the power input by means of at least one stirrer or by means of at least one stirrer and one pump, based on the reactor volume, is in the range from 1 to 4 kW/m³ or from 1.002 to 4.5 kW/in³, where in both cases at least one baffle is used and (i) no pump is used and the power input by means of at least one stirrer, based on the reactor volume, is in the range from 1 to 4 kW/m³, preferably from 1.2 to 3.5 kW/m³, or (ii) the combined power input by means of at least one stirrer and at least one pump, based on the reactor volume, is in the range from 1.002 to 4.5 kW/m³, preferably from 1.203 to 3.75 kW/m³, where the specific power input P when using a stirrer, based on the reactor volume, is calculated according to the formula P=Ne*n³* d⁵*ρ, where Ne is the Newton number, n is the stirrer speed in rpm, d is the stirrer diameter and ρ is the density of the reaction mixture, and the specific power input P, based on the reactor volume, when using a pump is calculated according to the formula P=Δp*rh, where Δp is the pressure drop between the pump outlet and the entry into the reactor (in Pa) and m is the flow rate (in m³/s). According to this publication a high batch-to-batch consistency can be ensured, i.e. the parameters of OH number and viscosity which are important for polyether polyols vary only slightly from batch to batch. Adequate mixing of the reaction mixture is ensured in the production process. Mixing can be achieved by stirring or circulation by pumping or by a combination of stirring and circulation by pumping. Criteria for good mixing are the power input based on the reactor volume and the pump circulation rate, with the latter also being able to be expressed as equivalent power input.

However, the above-mentioned publication is silent with respect to polyethercarbonate polyols. The examples given furthermore merely use of KOH and amine catalysts.

It would be desirable to improve a process for polyethercarbonate polyol synthesis in terms of power consumption. In particular, it would be desirable to reduce the amount of electrical power consumed during the process. At a minimum it would be desirable to keep the necessary specific power input at such a low limit, that a technical scale-up of the process is feasible without any disadvantages. At the same time with low specific power input, the product quality such as carbon dioxide incorporation should not be lower or side product formation (cyclic propylene carbonate) should not increase. Very high values of specific power input result in very costly mechanical construction and high energy cost consumption.

The present invention has the object of providing such a process without compromising product properties of currently marketed polyethercarbonate polyols.

According to the present invention this object is achieved by a process for the preparation of polyethercarbonate polyols comprising the reaction of a reaction mixture comprising one or more H-functional starter compounds, one or more alkylene oxides, carbon dioxide and a double metal cyanide (DMC) catalyst, wherein the reaction is conducted in a reactor under stirring with a specific power input into the reaction mixture, expressed as Watts per liter (W/L), of ≧0.07 to ≦5.00,

whereby the specific power input (P/V) is calculated
a) for the turbulent flow range the specific power input is calculated with:

P/V=Ne*n³*d⁵*density/V
with Ne=Newton number of the reactor; n=agitator speed; d=agitator diameter; density of the reaction mixture, V=filling volume (which is the volume of the reaction mixture at the end of the reaction), and
b) for the laminar flow range the specific power input is calculated with:

P/V=C*n²*d³*viscosity/V
with C=Re*Ne and Re=Reynolds number of the agitator used for mixing the reaction mixture, and Ne is the Newton number of the reactor.

The power input may be determined by measuring the electrical power consumed by the stirring motor(s) or calculated from rheological parameters, agitator type, geometry of reactor internals and the stirring speed. The calculation is described in the chapter “Stirring” by M. Zlokarnik as part of Ullmann's Encyclopedia of Industrial Chemistry, 2012, Wiley-VCH Verlag Weinheim and also in the experimental section further below.

It is preferred that the specific power input into the reaction mixture, expressed in Watts/liter, is ≧0.1 to ≦5.00, more preferred ≧0.25 to ≦5.0.

The energy-improved process according to the invention results in polyethercarbonate polyols with a high selectivity (i.e. low ratio of cyclic carbonate to polyethercarbonate polyol) and a narrow polydispersity index as well as high batch to batch consistency in the production of polyethercarbonate polyols.

According to the principles outlined in the Ullmann's reference cited above, the amount of gas dispersed in the reaction mixture increases with an increasing specific power input and vice versa. Therefore, it would have been expected that the copolymerization with carbon dioxide, a gas of low reactivity, would require a high specific power input, in general higher than that of a standard polyether reaction without carbon dioxide such as described in WO 2011/110484 A1. It was therefore expected that specific power input below the conventionally accepted values would lead to an expected lowering of dispersed gas in the liquid reaction mixture and eventually a collapse of the mass transfer process leading to an incomplete reaction. It is an insight provided by the present invention that the specific power input can be lowered substantially without adverse effects.

Furthermore, the formation of a high molecular weight tail in the molecular weight distribution of the obtained polyethercarbonate polyols can be avoided.

Details and preferred embodiments of the process according to the invention will be described in greater detail below. They may be combined freely unless the context clearly indicates otherwise.

In one embodiment of the process:
(α) the DMC catalyst, a suspending agent which comprises no H-functional groups and/or one or more H-functional starter compounds are initially introduced into the reactor,
(β) optionally, under an atmosphere of inert gas, inert gas/carbon dioxide mixture or under a carbon dioxide atmosphere, a fraction (based on the total amount of alkylene oxides used in steps (β) and (γ)) of one or more alkylene oxides is added into the reactor in one or more portions to the mixture from step (α) at temperatures of 50 to 200° C., preferably of 80 to 160° C. and particularly preferably of 125 to 135° C., and
(γ) one or more alkylene oxides, carbon dioxide and optionally one or more H-functional starter compounds are copolymerized in the reactor,
   characterized in that the copolymerisation (step (γ)) is conducted in a reactor under stirring with a specific power input into the reaction mixture, expressed as Watts per liter (W/L), of ≧0.07 to ≦5.00, preferably ≧0.1 to ≦5.00, more preferred ≧0.25 to ≦5.0.

It should be understood that if no H-functional starter compound is added in step (α), step (γ) always includes the addition of such an H-functional starter compound.

Step (α):

The individual components in step (α) can be added simultaneously or successively in any desired order; preferably, in step (α), the DMC catalyst is placed in the reactor first and the H-functional starter compound is added simultaneously or subsequently.

Another embodiment provides a process wherein, in step (α),

(α1) the H-functional starter compound or a mixture of at least two H-functional starter compounds is placed in the reactor, optionally under an inert gas atmosphere (e.g. nitrogen or argon), under an atmosphere of inert gas/carbon dioxide mixture or under a pure carbon dioxide atmosphere, particularly preferably under an inert gas atmosphere (e.g. nitrogen or argon), and

(α2) an inert gas (e.g. nitrogen or a noble gas such as argon), an inert gas/carbon dioxide mixture or carbon dioxide, particularly preferably an inert gas (e.g. nitrogen or argon), is passed into the resulting mixture of DMC catalyst and one or more H-functional starter compounds at a temperature of 50 to 200° C., preferably of 80 to 160° C. and particularly preferably of 125 to 135° C., and at the same time a reduced pressure (absolute) of 10 mbar to 800 mbar, preferably of 40 mbar to 200 mbar, is established in the reactor by removal of the inert gas or carbon dioxide (e.g. with a pump),

the double metal cyanide catalyst being added before or after the H-functional starter substance or the mixture of at least two H-functional starter substances.

The DMC catalyst can be added in solid form or as a suspension in an H-functional starter compound. If the DMC catalyst is added as a suspension, the latter is preferably added to the one or more H-functional starter compounds in step (α1).

Suitable non-H-functional suspension agents are all polar-aprotic, weakly polar-aprotic and unpolar solvents which do not contain any H-functional groups. Their mixtures are also suitable. By way of example, the following polar-aprotic solvents are given: 4-methyl-2-oxo-1,3-dioxolane (cyclic propylene carbonate, cPC), 1,3-dioxolan-2-one (cyclic ethylene carbonate, cEC), acetone, methyl ethyl ketone, acetonitrile, nitromethane, dimethyl sulfoxide, sulfolane, dimethyl formamide, dimethyl acetamide and N-methyl pyrrolidine. Examples for unpolar and weakly polar solvents are ethers such as dioxane, diethyl ether, MTBE and tetrahydrofurane; esters such as ethyl acetate and ethyl butyrate; hydrocarbons such as pentane, benzene and alkylated benzene derivatives (in particular, toluene, xylene and ethyl benzene) and chlorinated hydrocarbons such as chloroform, chlorobenzene, dichlorobenzene and tetrachloromethane. The preferred suspension agent is cyclic propylene carbonate.

Step (β):

The establishing of an atmosphere of inert gas/carbon dioxide mixture (e.g. nitrogen/carbon dioxide mixture or argon/carbon dioxide mixture) or a pure carbon dioxide atmosphere, and the metering of one or more alkylene oxides, can in principle be carried out in a variety of ways. The admission pressure is preferably established by introducing carbon dioxide, the pressure (absolute) being 10 mbar to 100 bar, preferably 100 mbar to 80 bar and particularly preferably 500 mbar to 50 bar. The metering of the alkylene oxide can start from the vacuum or at a preselected admission pressure. The total pressure (absolute) of the atmosphere of inert gas/carbon dioxide mixture (e.g. nitrogen/carbon dioxide mixture or argon/carbon dioxide mixture) or of a pure carbon dioxide atmosphere, and optionally alkylene oxide, in step (β) is established in the range preferably from 10 mbar to 100 bar, particularly preferably from 100 mbar to 80 bar and very particularly preferably from 500 mbar to 50 bar. Optionally, during or after the metering of the alkylene oxide, the pressure is adjusted by introducing more carbon dioxide, the pressure (absolute) being 10 mbar to 100 bar, preferably 100 mbar to 80 bar and particularly preferably 500 mbar to 50 bar.

Step (γ):

In the copolymerization (step (γ)), the metering of the one or more alkylene oxides and the carbon dioxide can take place simultaneously, alternately or sequentially. It is possible for the total amount of carbon dioxide to be added all at once or metered in over the reaction time. During the addition of the alkylene oxide, the CO₂ pressure can be raised or lowered gradually or stepwise or left as it is. Preferably, the total pressure is kept constant during the reaction via a pressure regulated addition of carbon dioxide. The metering of the one or more alkylene oxides or the CO₂ takes place simultaneously, alternately or sequentially in relation to the metering of the carbon dioxide. It is possible to meter the alkylene oxide in at a constant rate, to raise or lower the metering rate gradually or stepwise, or to add the alkylene oxide in portions. Preferably, the alkylene oxide is added to the reaction mixture at a constant metering rate. If several alkylene oxides are used to synthesize the polyethercarbonate polyols, the alkylene oxides can be metered in individually or as a mixture. The metering of the alkylene oxides can take place simultaneously, alternately or sequentially by means of separate metering (addition) operations or by means of one or more metering operations, it being possible for the alkylene oxides to be metered in individually or as a mixture. By varying the type and/or order of metering of the alkylene oxides and/or carbon dioxide, it is possible to synthesize random, alternating, block or gradient polyethercarbonate polyols.

It is preferable to use an excess of carbon dioxide based on the calculated amount of incorporated carbon dioxide in the polyethercarbonate polyol, an excess of carbon dioxide being advantageous due to its inertness. The amount of carbon dioxide can be determined from the total pressure under the particular reaction conditions. The range from 0.01 to 120 bar, preferably from 0.1 to 110 bar and particularly preferably from 1 to 100 bar has proved advantageous as the total pressure (absolute) for the copolymerization to prepare the polyethercarbonate polyols. The carbon dioxide can be introduced continuously or batchwise. This depends on how quickly the alkylene oxides and the CO₂ are consumed and whether the product is optionally to contain CO₂-free polyether blocks or blocks with different CO₂ contents. The amount of carbon dioxide (given as pressure) can likewise vary when the alkylene oxides are added. According to the chosen reaction conditions, it is possible to introduce the CO₂ into the reactor in the gaseous, liquid or supercritical state. CO₂ can also be fed into the reactor as a solid and then change into the gaseous, dissolved, liquid and/or supercritical state under the chosen reaction conditions.

For the process according to the invention it has further been found that the copolymerization (step (γ)) to prepare the polyethercarbonate polyols is advantageously carried out at 50 to 150° C., preferably at 60 to 145° C., particularly preferably at 70 to 140° C. and very particularly preferably at 90 to 130° C. Below 50 ° C. the reaction only proceeds very slowly. At temperatures above 150° C. the amount of unwanted by-products increases sharply.

In steps (β) and/or (γ) the carbon dioxide is preferably introduced into the mixture by
(i) feeding gas into the reaction mixture from underneath the reactor (e.g. via an inlet tube or a gas dispersion ring with the gas being led underneath the agitator blade) and, depending on the gas load, optionally in combination with a gas dispersion agitator (e.g. disk agitator, straight-blade turbine, Rushton turbine (e.g. Lightnin R-100®, Ekato PHASE-JET®, Smith-Turbine® from Philadelphia Mixing Solutions, Chemineer BT-6® or CD-6® agitator blades)), there optionally being further agitating elements (of any desired type, e.g. turbines that convey axially according to the slenderness ratio of the reactor, or agitating elements that support heat transfer to inner-lying cooling surfaces and/or promote mass transfer over the liquid surface) arranged on the agitator shaft; a combination of two or more agitating elements has the technical advantage of being able to improve the mass transfer of the gas into the liquid phase on the surface of the reaction mixture;
(ii) using a hollow shaft agitator (i.e. using the principle of the air jet pump), e.g. as a tubular agitator, pitched-blade turbine with hollow blades, Ekato GASJET®, PREMEX laboratory gas dispersion agitator of the “br” series, or laboratory gas dispersion agitator from Parr Instruments; the effect of using a hollow shaft agitator is that the gas phase accumulating in the gas space is aspirated through a hollow shaft and fed back into the reaction mixture from underneath;
(iii) combining the metering operations according to (i) and (ii), which is advantageous for operating with a constant filling level in the reactor; for example, the metering operations according to (i) and (ii) can be combined in such a way that the feeding of gas into the reaction mixture from underneath the reactor according to one of the possibilities mentioned under (i) is combined with a hollow shaft agitator according to (ii) (e.g. a gas dispersion agitator with an air jet pump arranged on top as a second dispersion stage), preferably in such a way that the introduction of the gas from below takes place underneath the hollow shaft agitator; and/or
(iv) feeding gas over the liquid surface using appropriate agitating elements, typically of multistage design (e.g. MIG or Ekato MIGIINTERMIG®), or by means of agitating elements acting on the liquid surface (e.g. gate agitator).

The reactor optionally contains internal fittings such as flow spoilers and/or cooling surfaces (in the form of a tube, a coil, plates or the like), a gas dispersion ring and/or an inlet tube. Other heat exchange surfaces can be arranged in a pump circuit, in which case the reaction mixture is conveyed by suitable pumps (e.g. screw pump, centrifugal pump or gear pump). Here the circulating stream can be recycled into the reactor, e.g. also via an injector nozzle, whereby part of the gas space is aspirated and intimately mixed with the liquid phase for the purpose of improving the mass transfer.

The feeding of gas into the reaction mixture in the reactor according to (i) preferably takes place via a gas dispersion ring, a gas dispersion nozzle or a gas inlet tube. The gas dispersion ring is preferably an annular arrangement or two or more annular arrangements of gas dispersion nozzles preferably located on the bottom and/or side wall of the reactor.

The hollow shaft agitator is preferably an agitator in which the gas is introduced into the reaction mixture through a hollow shaft of the agitator. As the agitator rotates in the reaction mixture (i.e. during mixing), a pressure reduction is created at the end of the agitator blade connected to the hollow shaft, whereupon the gas phase (containing CO₂ and optionally unconsumed alkylene oxide) is aspirated out of the gas space above the reaction mixture and passed through the hollow shaft of the agitator into the reaction mixture.

The feeding of gas into the reaction mixture according to (i), (ii), (iii) or (iv) can be effected in each case with freshly metered carbon dioxide (and/or be combined with aspiration of the gas out of the gas space above the reaction mixture and subsequent recompression of the gas). For example, the gas which has been aspirated out of the gas space above the reaction mixture and compressed is introduced into the reaction mixture according to (i), (ii), (iii) and/or (iv), optionally mixed with fresh carbon dioxide and/or alkylene oxide. Preferably, the pressure drop arising from the incorporation of carbon dioxide and alkylene oxide into the reaction product during copolymerization is compensated with freshly metered carbon dioxide.

The alkylene oxide can be introduced separately or together with the CO₂, either via the liquid surface or direct into the liquid phase. The alkylene oxide is preferably introduced directly into the liquid phase because this has the advantage of a rapid and thorough mixing of the incorporated alkylene oxide with the liquid phase, thereby avoiding concentration hotspots of alkylene oxide. The introduction into the liquid phase can be effected via one or more inlet tubes, one or more nozzles or one or more annular arrangements of multiple metering points preferably located on the bottom and/or side wall of the reactor.

In another preferred embodiment of the process according to the invention after step (α) an inert gas, an inert gas/carbon dioxide mixture or carbon dioxide is passed through the reaction mixture at a temperature of ≧115° C. to ≦150° C. and at the same time a reduced pressure (absolute) of 10 mbar to 800 mbar is established in the reactor by removal of the inert gas or carbon dioxide. The preferred temperature range is ≧125° C. to ≦135° C. These temperature ranges correspond to what is described as a “strong” drying of the DMC catalyst. A strongly dried DMC catalyst generally provides a higher activity in the copolymerisation step.

In another preferred embodiment of the process according to the invention after step (α) an inert gas/carbon dioxide mixture or carbon dioxide is passed through the reaction mixture at a temperature of ≧80° C. to ≦115° C. and at the same time a reduced pressure (absolute) of 10 mbar to 800 mbar is established in the reactor by removal of the inert gas or carbon dioxide. The preferred temperature range here is ≧95° C. to ≦105° C. These temperature ranges correspond to what is described as a “weak” drying of the DMC catalyst. A weakly dried DMC catalyst generally provides a higher selectivity to the polyethercarbonate polyol and a higher CO₂ content in the polyethercarbonate polyol.

In another preferred embodiment of the process according to the invention the stirring is conducted at a constant speed.

In another preferred embodiment of the process according to the invention the specific power input is determined after the volume of the reaction mixture has obtained a constant value.

In another preferred embodiment of the process according to the invention the stirring is conducted using any kind and/or combination of radial or axial flow agitator such as a turbine stirrer, an impeller, a cross-beam stirrer, a grid stirrer, a blade stirrer, an anchor stirrer, a pitched blade stirrer, a propeller, a cross-beam stirrer with inclined blades, a MIG starer or a helical ribbon stirrer. A preferred combination is a hydrofoil impeller together with a Rushton turbine (or its further developments) in order to improve the gas dispersion in the vicinity of the CO₂ and alkylene oxide intake.

The three steps (α), (β) and (γ) can be carried out in the same reactor or separately in different reactors. Particularly preferred types of reactor are agitated tanks, tubular reactors and loop reactors. If reaction steps (α), (β) and (γ) are carried out in different reactors, a different type of reactor can be used for each step.

Preferably, the reaction is carried out in:
an agitated tank reactor which optionally comprises an external loop with pump that recirculates material back into the reactor,
a tubular reactor which optionally comprises an external loop with pump that recirculates material back into the reactor, or
a loop reactor;
the reactors furthermore optionally comprising an external heat exchanger.

Polyethercarbonate polyols can for example be prepared in an agitated tank, the latter being cooled via the reactor jacket, internal cooling surfaces and/or cooling surfaces located in a pump circuit, depending on the embodiment and mode of operation. In both semi-batch operation, where the product is not removed until after the reaction has ended, and continuous operation, where the product is removed continuously, particular attention must be paid to the metering rate of the alkylene oxide. It is to be adjusted so that the alkylene oxides react sufficiently rapidly despite the inhibitory effect of the carbon dioxide.

In another embodiment, the concentration of free alkoxides during the reaction is >0 to ≦10 weight-%, based on the total weight of the reaction mixture. A preferred concentration is >0 to ≦5 weight-%. In particular, the concentration of free alkylene oxides in the reaction mixture during the activation step (step (β)) is preferably >0 to ≦10 or >0 to ≦5 wt. % (based in each case on the weight of the reaction mixture) and furthermore, the concentration of free alkylene oxides in the reaction mixture during the copolymerization (step (γ)) is preferably >0 to ≦10 or >0 to ≦5 wt. %

(based in each case on the weight of the reaction mixture).

In another embodiment, the one or more H-functional starter compounds and one or more alkylene oxides are metered continuously in the presence of carbon dioxide into the reactor.

In another embodiment, the DMC catalyst is metered continuously into the reactor, the resulting reaction mixture comprising polyethercarbonate polyols is removed continuously from the reactor and one or more H-functional starter compounds are metered continuously into the reactor.

Another possible embodiment in the agitated tank for the copolymerization (step γ)) is characterized in that one or more H-functional starter compounds are metered continuously into the reactor during the reaction. In one mode of carrying out the process in the semi-batch operation, the amount of H-functional starter compounds metered continuously into the reactor during the reaction is preferably at least 20 mol % equivalent, particularly preferably 70 to 95 mol % equivalent (based in each case on the total amount of H-functional starter compounds). In one continuous mode of carrying out the process, the amount of H-functional starter compounds metered continuously into the reactor during the reaction is preferably at least 80 mol % equivalent, particularly preferably 95 to 100 mol % equivalent (based in each case on the total amount of H-functional starter compounds).

In one preferred embodiment, the catalyst/starter mixture activated according to steps (α) and (β) is reacted further according to step (γ) with alkylene oxides, H-functional starter and carbon dioxide in the same reactor. In another preferred embodiment, the catalyst/starter mixture activated according to steps (α) and (β) is reacted further with alkylene oxides H-functional starters and carbon dioxide in a different reaction vessel (e.g. an agitated tank, tubular reactor or loop reactor). In another preferred embodiment, the catalyst/starter mixture dried according to step (α) is reacted with alkylene oxides, carbon dioxide and H-functional starter in a different reaction vessel (e.g. an agitated tank, tubular reactor or loop reactor) according to steps (β) and (γ).

If the reaction is carried out in a tubular reactor, the catalyst/starter mixture dried according to step (α) or the catalyst/starter mixture activated according to steps (α) and (β), and optionally other starters as well as the alkylene oxides and carbon dioxide, are pumped continuously through a tube. If a catalyst/starter mixture dried according to step (α) is used, the activation according to step (β) takes place in the first part of the tubular reactor and the copolymerization according to step (γ) in the second part of the tubular reactor. The molar ratios of the reactants vary according to the desired polymer. In one preferred embodiment, the carbon dioxide is metered in its liquid or supercritical form so as to optimize the miscibility of the components. The carbon dioxide can be introduced into the reactor at its inlet and/or via metering points arranged along the reactor. A fraction of the epoxide can be introduced at the reactor inlet. The remainder of the epoxide is preferably introduced into the reactor via several metering points arranged along the reactor. It is advantageous to incorporate mixing elements to improve the thorough mixing of the reactants, examples being those marketed by Ehrfeld Mikrotechnik BTS GmbH, or mixing/heat exchange elements to simultaneously improve thorough mixing and heat dissipation. Preferably, CO₂ and/or alkylene oxide metered in through the mixing elements are mixed with the reaction mixture. In one alternative embodiment, different volume elements of the reaction mixture are mixed with one another.

Loop reactors can also be used to prepare polyethercarbonate polyols. These generally include reactors with internal and/or external material recycling (optionally with heat exchange surfaces arranged in the circuit), such as a jet loop or venturi loop reactor, which can also be operated continuously, or a tubular reactor designed as a loop with suitable devices for circulating the reaction mixture, or a loop of several tubular reactors connected in series or several agitated tanks connected in series or a stirred tank reactor with an external pump installed in a pipe loop circuit.

To achieve full conversion, another tank or a tube (tube post-reactor), in which residual concentrations of free alkylene oxides present after the reaction react, is commonly connected downstream of the reaction apparatus in which step (γ) is carried out. Preferably, the pressure in this downstream reactor is the same as that in the reaction apparatus in which reaction step (γ) is carried out. However, the pressure in the downstream reactor can also be chosen higher or lower. In another preferred embodiment, all or some of the carbon dioxide is exhausted after reaction step (γ) and the downstream reactor is operated at normal pressure or a slight excess pressure. The temperature in the downstream reactor is preferably 10 to 150° C., particularly preferably 20 to 120° C. At the end of the downstream reactor the reaction mixture preferably contains less than 0.05 wt. % of alkylene oxide.

The process according to the invention can generally be carried out using alkylene oxides (epoxides) having 2-45 carbon atoms. Examples of alkylene oxides having 2-45 carbon atoms are one or more compounds selected from the group comprising ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, monoepoxy or polyepoxy fats as mono-, di- and triglycerides, epoxy fatty acids, C₁-C₂₄ esters of epoxy fatty acids, epichlorohydrin, glycidol, and glycidol derivatives such as methyl glycidyl ether, ethyl glycidyl ether, 2-ethylhexyl glycidyl ether, allyl glycidyl ether, glycidyl methacrylate and epoxy-functional alkoxysilanes like 3-glycidyloxypropyltrimethoxysilane, 3-glyeidyloxypropyltriethoxysilane, 3 -glycidyl-oxypropyltripropoxysilane, 3-glycidyloxypropylmethyldimethoxysilane, 3-glycidyl-oxypropylethyldiethoxysilane and 3-glycidyloxypropyltriisopropoxysilane. The alkylene oxides used are preferably ethylene oxide and/or propylene oxide, especially propylene oxide.

Suitable H-functional starter compounds which can be used are compounds with H atoms that are active for alkoxylation. Examples of groups with H atoms that are active for alkoxylation are —OH, —NH₂ (primary amines), —NH— (secondary amines), —SH and —CO₂H; —OH and —NH₂ are preferred and —OH is particularly preferred. Examples of H-functional starter substances used are one or more compounds selected from the group comprising monohydric alcohols, polyhydric alcohols, polybasic amines, polyhydric thiols, amino alcohols, thio alcohols, hydroxy esters, polyether polyols, polyester polyols, polyesterether polyols, polycarbonate polyols, polyethercarbonate polyols, polyethyleneimines, polyetheramines (e.g. so-called Jeffamine® from Huntsman, such as D-230, D-400, D-2000, T-403, T-3000 or T-5000, or corresponding products from BASF, such as polyetheramine D230, D400, D200, T403 or T5000), polytetrahydrofurans (e.g. PolyTHF® from BASF, such as PolyTHF® 250, 650S, 1000, 1000S, 1400, 1800 or 2000), polytetrahydrofuranamines (BASF product polytetrahydrofuranamine 1700), polyetherthiols, polyacrylate polyols, castor oil, ricinoleic acid mono- or diglyceride, fatty acid monoglycerides, chemically modified fatty acid mono-, di- and/or triglycerides, and fatty acid C ₁-C₂₄-alkyl esters containing an average of at least 2 OH groups per molecule. Examples of fatty acid C₁-C₂₄-alkyl esters containing an average of at least 2 OH groups per molecule are commercially available products such as Lupranol Balance® (BASF AG), various types of Merginol® (Hobum Oleochemicals GmbH), various types of Sovernol® (Cognis Deutschland GmbH & Co. KG) and various types of Soya® TM (USSC Co.).

Monofunctional starter compounds which can be used are alcohols, amines, thiols and carboxylic acids. The following monofunctional alcohols can be used: methanol, ethanol, 1-propanol, 2-propanol, 1-butanol, 2-butanol, tert-butanol, 3-buten-1-ol, 3-butyn-1-ol, 2-methyl-3-bute n-2-ol, 2-methyl-3-butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxy-biphenyl, 4-hydroxybiphenyl, 2-hydroxypyridine, 3-hydroxypyridine, 4-hydroxypyridine. The following monofunctional amines are suitable: butylamine, tert-butylamine, pentylamine, hexylamine, aniline, aziridine, pyrrolidine, piperidine, morpholine. The following monofunctional thiols can be used: ethanethiol, 1-propanethiol, 2-propanethiol, 1-butanethiol, 3-methyl-1-butanethiol, 2-butene-1-thiol, thiophenol. The following monofunctional carboxylic acids may be mentioned: formic acid, acetic acid, propionic acid, butyric acid, fatty acids such as stearic acid, palmitic acid, oleic acid, linoleic acid and linolenic acid, benzoic acid, acrylic acid.

Examples of polyhydric alcohols suitable as H-functional starter compounds are selected from at least one of the group comprising ethylene glycol, propylene glycol, 1,3-propanediol, 1,3-butanediol, 1,4-butanediol, 1,5-pentanediol, 2-methylpropane-1,3-diol, neopentyl glycol, 1,6-hexanediol, 1,8-octanediol, diethylene glycol, dipropylene glycol, glycerol, trimethylolpropane and di- and trifunctional polyether polyols, the polyether polyol being made up of a di- or tri-H-functional starter substance and propylene oxide or a di- or tri-H-functional starter substance, propylene oxide and ethylene oxide, and the polyether polyols having a molecular weight Mₙ ranging from 62 to 4500 g/mol and a functionality of 2 to 3.

The H-functional starter compounds can also be selected from the class of compounds comprising the polyether polyols, especially those with a molecular weight Mₙ ranging from 100 to 4000 g/mol. Preferred polyether polyols are those made up of repeating ethylene oxide and propylene oxide units, preferably with a proportion of 35 to 100% of propylene oxide units and particularly preferably with a proportion of 50 to 100% of propylene oxide units. They can be random copolymers, gradient copolymers or alternating or block copolymers of ethylene oxide and propylene oxide. Examples of suitable polyether polyols made up of repeating propylene oxide and/or ethylene oxide units are the Desmophen®, Acclaim®, Arcol®, Baycoll®, Bayfill®, Bayflex®, Baygal®, PET® and Polyether® Polyols from Bayer MaterialScience AG (e.g. Desmophen® 3600Z, Desmophen® 1900U, Acclaim® Polyol 2200, Acclaim® Polyol 40001, Arcol® Polyol 1004, Arcol® Polyol 1010, Arcol® Polyol 1030, Arcol® Polyol 1070, Baycoll® BD 1110, Bayfill® VPPU 0789, Baygal® K55, PET® 1004, Polyether® S180). Examples of other suitable homo-polyethylene oxides are the Pluriol® E brands from BASF SE, examples of suitable homo-polypropylene oxides are the Pluriol P brands from BASF SE, and examples of suitable mixed copolymers of ethylene oxide and propylene oxide are the Pluronic® PE or Pluriol® RPE brands from BASF SE.

The H-functional starter compounds can also be selected from the class of compounds comprising the polyester polyols, especially those with a molecular weight Mₙ ranging from 200 to 4500 g/mol. The polyester polyols used are at least difunctional polyesters and preferably consist of alternating acid and alcohol units. Examples of acid components used are succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures of said acids and/or anhydrides. Examples of alcohol components used are ethanediol, 1,2-propanediol, 1,3-propanediol, 1,4-butanediol, 1,5-pentanediol, neopentyl glycol, 1,6-hexanediol, 1,4-bis(hydroxymethyl)-cyclohexane, diethylene glycol, dipropylene glycol, trimethylolpropane, glycerol, pentaerythritol or mixtures of said alcohols. If dihydric or polyhydric polyether polyols are used as the alcohol component, polyesterether polyols are obtained which can also be used as starter substances for preparing the polyethercarbonate polyols. It is preferable to use polyether polyols of Mₙ=150 to 2000 g/mol to prepare the polyesterether polyols.

Other H-functional starter compounds which can be used are polycarbonate diols, especially those with a molecular weight Mₙ ranging from 150 to 4500 g/mol, preferably from 500 to 2500 g/mol, which are prepared e.g. by reacting phosgene, dimethyl carbonate, diethyl carbonate or diphenyl carbonate with difunctional alcohols, polyester polyols or polyether polyols. Examples of polycarbonates can be found e.g. in EP-A 1359177. Examples of polycarbonate diols which can be used are the Desmophen® C types from Bayer MaterialScience AG, such as Desmophen® C 1100 or Desmophen® C 2200.

In another embodiment of the invention, polyethercarbonate polyols can be used as H-functional starter compounds. The polyethercarbonate polyols obtainable by the process according to the invention described here are used in particular. These polyethercarbonate polyols used as H-functional starter compounds are previously prepared for this purpose in a separate reaction step.

The H-functional starter compounds generally have an OH functionality (i.e. number of H atoms per molecule that are active for polymerization) of 1 to 8, preferably of 2 to 6 and particularly preferably of 2 to 4. The H-functional starter compounds are used either individually or as a mixture of at least two H-functional starter compounds.

Preferred H-functional starter compounds are alcohols of general formula:

HO—(CH₂)ₓ—OH

where x is a number from 1 to 20, preferably an even number from 2 to 20. Examples are ethylene glycol, 1,4-butanediol, 1,6-hexanediol, 1,8-octanediol, 1,10-decanediol and 1,12-dodecanediol. Other preferred H-functional starter compounds are neopentyl glycol, trimethylolpropane, glycerol, pentaerythritol, and reaction products of the alcohols of the above formula with ε-caprolactone, e.g. reaction products of trimethylolpropane with ε-caprolactone, reaction products of glycerol with ε-caprolactone and reaction products of pentaerythritol with ε-caprolactone. Other H-functional starter compounds which are preferably used are water, diethylene glycol, dipropylene glycol, castor oil, sorbitol, and polyether polyols made up of repeating polyalkylene oxide units.

Particularly preferably, the H-functional starter compounds are one or more compounds selected from the group comprising ethylene glycol, propylene glycol, 1,3-propanediol, 1,3-butanediol, 1,4-butanediol, 1,5-pentanediol, 2-methylpropane-1,3-diol, neopentyl glycol, 1,6-hexanediol, diethylene glycol, dipropylene glycol, glycerol, trimethylolpropane and di- and trifunctional polyether polyols, the polyether polyol being made up of a di- or tri-H-functional starter compound and propylene oxide or a di- or tri-H-functional starter compound, propylene oxide and ethylene oxide. The polyether polyols preferably have an OH functionality of 2 to 4 and a molecular weight Ma ranging from 62 to 4500 g/mol, especially a molecular weight Mₙ ranging from 62 to 3000 g/mol.

The polyethercarbonate polyols are prepared by the catalytic addition of carbon dioxide and alkylene oxides on to H-functional starter substances. In terms of the invention, “n-functional” is understood as meaning the number n of H atoms per molecule of starter compound that are active for alkoxylation.

DMC catalysts for use in the homopolymerization of alkylene oxides are known in principle (cf., for example, U.S. Pat. No. 3,404,109, U.S. Pat. No. 3,829,505, U.S. Pat. No. 3,941,849 and U.S. Pat. No. 5,158,922). DMC catalysts described e.g. in U.S. Pat. No. 5,470,813, EP-A 700 949, EP-A 743 093, EP-A 761 708, WO 97/40086, WO 98/16310 and WO 00/47649 have a very high activity and enable polyether-carbonate polyols to be prepared with very low catalyst concentrations. Typical examples are the highly active DMC catalysts described in EP-A 700 949, which, in addition to a double metal cyanide compound (e.g. zinc hexacyanocobaltate(III)) and an organic complexing ligand (e.g. tert-butanol), also contain a polyether with a number-average molecular weight greater than 500 g/mol.

The DMC catalysts are preferably obtained by a process in which
(a) in the first step, an aqueous solution of a metal salt is reacted with an aqueous solution of a metal cyanide salt in the presence of one or more organic complexing ligands, e.g. an ether or alcohol,
(b) in the second step, the solid is separated from the suspension obtained in (i) by known techniques (such as centrifugation or filtration),
(c) optionally, in a third step, the isolated solid is washed with an aqueous solution of an organic complexing ligand (e.g. by resuspension and then re-isolation by filtration or centrifugation), and
(d) the solid obtained is then dried, optionally after pulverization, at temperatures generally of 20-120° C. and at pressures generally of 0.1 mbar to normal pressure (1013 mbar),
   one or more organic complexing ligands, preferably in excess (based on the double metal cyanide compound), and optionally other complexing components, being added in the first step or immediately after the precipitation of the double metal cyanide compound (second step).

The double metal cyanide compounds contained in the DMC catalysts are the reaction products of water-soluble metal salts and water-soluble metal cyanide salts.

For example, an aqueous solution of zinc chloride (preferably in excess, based on the metal cyanide salt, e.g. potassium hexacyanocobaltate) and potassium hexacyanocobaltate are mixed and dimethoxyethane (glyme) or tert-butanol (preferably in excess, based on zinc hexacyanocobaltate) is then added to the suspension formed.

Metal salts suitable for preparing the double metal cyanide compounds preferably have the general formula:

M(X)ₙ

where

M is selected from the metal cations Zn²⁺, Fe²⁺, Mn²⁺, Co²⁺, Sr²⁺, Sn²⁺, Pb²⁺ and Cu²⁺, M preferably being Zn²⁺, Fe²⁺, Co²⁺ or Ni²⁺;

X are one or more (i.e. different) anions, preferably an anion selected from the group comprising halides (i.e. fluoride, chloride, bromide, iodide), hydroxide, sulfate, carbonate, cyanate, thiocyanate, isocyanate, isothiocyanate, carboxylate, oxalate and nitrate;

n is 1 when X=sulfate, carbonate or oxalate; and

n is 2 when X=halide, hydroxide, carboxylate, cyanate, thiocyanate, isocyanate, isothiocyanate or nitrate,

or suitable metal salts have the general formula:

Mᵣ(X)₃

where

M is selected from the metal cations Fe³⁺, Al³⁺, Co³⁺ and Cr³⁺;

X are one or more (i.e. different) anions, preferably an anion selected from the group comprising halides (i.e. fluoride, chloride, bromide, iodide), hydroxide, sulfate, carbonate, cyanate, thiocyanate, isocyanate, isothiocyanate, carboxylate, oxalate and nitrate;

r is 2 when X=sulfate, carbonate or oxalate; and

r is 1 when X=halide, hydroxide, carboxylate, cyanate, thiocyanate, isocyanate, isothiocyanate or nitrate,

or suitable metal salts have the general formula:

M(X)ₛ

where

M is selected from the metal cations Mo⁴⁺, V⁴⁺ and W⁴⁺;

X are one or more (i.e. different) anions, preferably an anion selected from the group comprising halides (i.e. fluoride, chloride, bromide, iodide), hydroxide, sulfate, carbonate, cyanate, thiocyanate, isocyanate, isothiocyanate, carboxylate, oxalate and nitrate;

s is 2 when X=sulfate, carbonate or oxalate; and

s is 4 when X=halide, hydroxide, carboxylate, cyanate, thiocyanate, isocyanate, isothiocyanate or nitrate,

or suitable metal salts have the general formula:

M(X)ₜ

where

M is selected from the metal cations Mo⁶⁺ and W⁶⁺;

X are one or more (i.e. different) anions, preferably an anion selected from the group comprising halides (i.e. fluoride, chloride, bromide, iodide), hydroxide, sulfate, carbonate, cyanate, thiocyanate, isocyanate, isothiocyanate, carboxylate, oxalate and nitrate;

t is 3 when X=sulfate, carbonate or oxalate; and

t is 6 when X=halide, hydroxide, carboxylate, cyanate, thiocyanate, isocyanate, isothiocyanate or nitrate.

Examples of suitable metal salts are zinc chloride, zinc bromide, zinc iodide, zinc acetate, zinc-acetylacetonate, zinc benzoate, zinc nitrate, iron(II) sulfate, iron(II) bromide, iron(II) chloride, iron(III) chloride, cobalt(II) chloride, cobalt(II) thiocyanate, nickel(II) chloride and nickel(II) nitrate. It is also possible to use mixtures of different metal salts.

Metal cyanide salts suitable for preparing the double metal cyanide compounds preferably have the general formula:

(Y)ₐ M′(CN)_{b}(A)_{c}

where

M′ is selected from one or more metal cations from the group comprising Fe(II), Fe(III), Co(II), Co(III), Cr(II), Cr(III), Mn(II), Mn(III), Ir(III), Ni(II), Rh(III), Ru(II), V(IV) and V(V), M′ preferably being one or more metal cations from the group comprising Co(II), Co(III), Fe(II), Fe(III), Cr(III), Ir(III) and Ni(II);

Y is selected from one or more metal cations from the group comprising alkali metals (i.e. Li⁺, Na⁺, K⁺, Rb⁺) and alkaline earth metals (i.e. Be²⁺, Mg²⁺, Ca²⁺, Ba²⁺);

A is selected from one or more anions from the group comprising halides (i.e. fluoride, chloride, bromide, iodide), hydroxide, sulfate, carbonate, cyanate, thiocyanate, isocyanate, isothiocyanate, carboxylate, azide, oxalate and nitrate; and

a, b and c are integers, the values of a, b and c being chosen so that the metal cyanide salt is electrically neutral; a is preferably 1, 2, 3 or 4; b is preferably 4, 5 or 6; c preferably has the value 0.

Examples of suitable metal cyanide salts are sodium hexacyanocobaltate(III), potassium hexacyanocobaltate(III), potassium hexacyanoferrate(II), potassium hexacyanoferrate(III), calcium hexacyanocobaltate(III) and lithium hexacyanocobaltate(III).

Preferred double metal cyanide compounds contained in the DMC catalysts are compounds of general formula:

Mₓ[M′_{x′},(CN)_{y}]_{z}

where

M is as defined above;

M′ is as defined above; and

x, x′, y and z are integers and are chosen so that the double metal cyanide compound is electrically neutral.

Preferably:

x=3, x′=1, y=6 and z=2;

M=Zn(II), Fe(II), Co(II) or Ni(II); and

M′=Co(III), Fe(III), Cr(III) or Ir(III).

Examples of suitable double metal cyanide compounds a) are zinc hexacyanocobaltate(III), zinc-hexacyanoiridate(III), zinc hexacyanoferrate(III) and cobalt(II) hexacyanocobaltate(III). Other examples of suitable double metal cyanide compounds can be found e.g. in U.S. Pat. No. 5,158,922 (column 8, lines 29-66). It is particularly preferable to use zinc hexacyanocobaltate(III).

The organic complexing ligands added in the preparation of the DMC catalysts are disclosed e.g. in U.S. Pat. No. 5,158,922 (cf. especially column 6, lines 9 to 65), U.S. Pat. No. 3,404,109, U.S. Pat. No. 3,829,505, U.S. Pat. No. 3,941,849, EP-A 700 949, EP-A 761 708, JP 4 145 123, U.S. Pat. No. 5,470,813, EP-A 743 093 and WO-A 97/40086). For example, water-soluble organic compounds with heteroatoms, such as oxygen, nitrogen, phosphorus or sulfur, which can form complexes with the double metal cyanide compound are used as organic complexing ligands. Preferred organic complexing ligands are alcohols, aldehydes, ketones, ethers, esters, amides, ureas, nitriles, sulfides and mixtures thereof. Particularly preferred organic complexing ligands are aliphatic ethers (such as dimethoxyethane), water-soluble aliphatic alcohols (such as ethanol, isopropanol, n-butanol, isobutanol, sec-butanol, tert-butanol, 2-methyl-3-buten-2-ol and 2-methyl-3-butyn-2-ol), and compounds containing both aliphatic or cycloaliphatic ether groups and aliphatic hydroxyl groups (e.g. ethylene glycol mono-tert-butyl ether, diethylene glycol mono-tert-butyl ether, tripropylene glycol monomethyl ether and 3-methyl-3-oxetane-methanol). Very particularly preferred organic complexing ligands are selected from one or more compounds from the group comprising dimethoxyethane, tert-butanol, 2-methyl-3-buten-2-ol, 2-methyl-3-butyn-2-ol, ethylene glycol mono-tert-butyl ether and 3-methyl-3-oxetanemethanol.

Optionally, one or more complexing components from the following classes of compounds are used in the preparation of the DMC catalysts: polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylic acid-co-maleic acid), polyacrylonitrile, polyalkyl-acrylates, polyalkyl methacrylates, polyvinyl methyl ether, polyvinyl ethyl ether, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkyleneimines, maleic acid and maleic anhydride copolymers, hydroxyethyl cellulose and polyacetals, or glycidyl ethers, glycosides, carboxylic acid esters of polyhydric alcohols, gallic acids or their salts, esters or amides, cyclodextrins, phosphorus compounds, α,β-unsaturated carboxylic acid esters or ionic surface-active compounds.

Preferably, in the first step of the preparation of the DMC catalysts, the aqueous solution of the metal salt (e.g. zinc chloride), used in stoichiometric excess (at least 50 mol %, based on the metal cyanide salt, i.e. a molar ratio of metal salt to metal cyanide salt of at least 2.25 to 1.00) is reacted with the aqueous solution of the metal cyanide salt (e.g. potassium hexacyanocobaltate) in the presence of the organic complexing ligand (e.g. tert-butanol) to form a suspension containing the double metal cyanide compound (e.g. zinc hexacyanocobaltate), water, excess metal salt and the organic complexing ligand.

The organic complexing ligand can be present in the aqueous solution of the metal salt and/or the aqueous solution of the metal cyanide salt, or it is added immediately to the suspension obtained after precipitation of the double metal cyanide compound. It has been found advantageous to mix the aqueous solutions of the metal salt and metal cyanide salt and the organic complexing ligand with vigorous agitation. Optionally, the suspension formed in the first step is then treated with another complexing component, the latter preferably being used in a mixture with water and organic complexing ligand. A preferred procedure for carrying out the first step (i.e. preparation of the suspension) involves the use of a mixing nozzle, particularly preferably a jet disperser as described in WO-A 01/39883.

In the second step, the isolation of the solid (i.e. the precursor of the catalyst according to the invention) from the suspension is effected by known techniques such as centrifugation or filtration.

In one preferred embodiment, the isolated solid is then washed, in a third process step, with an aqueous solution of the organic complexing ligand (e.g. by resuspension and then re-isolation by filtration or centrifugation). This makes it possible e.g. to remove water-soluble by-products, such as potassium chloride, from the catalyst. Preferably, the amount of organic complexing ligand in the aqueous wash solution is between 40 and 80 wt. %, based on the total solution.

Optionally, another complexing component, preferably in the range between 0.5 and 5 wt. %, based on the total solution, is added to the aqueous wash solution in the third step.

It is moreover advantageous to wash the isolated solid more than once. Preferably, a first washing step is carried out with an aqueous solution of the organic complexing ligand (e.g. by resuspension and then re-isolation by filtration or centrifugation) in order e.g. to remove water-soluble by-products, such as potassium chloride, from the catalyst according to the invention. Particularly preferably, the amount of organic complexing ligand in the aqueous wash solution is between 40 and 80 wt. %, based on the total solution of the first washing step. In the other washing steps, either the first washing step is repeated one or more times, preferably one to three times, or, preferably, a non-aqueous solution, e.g. a mixture or solution of organic complexing ligand and another complexing component (preferably in the range between 0.5 and 5 wt. %, based on the total amount of wash solution of the second washing step), is used as the wash solution and the solid is washed therewith one or more times, preferably one to three times.

The isolated and optionally washed solid is then dried, optionally after pulverization, at temperatures generally of 20-100° C. and at pressures generally of 0.1 mbar to normal pressure (1013 mbar).

A preferred procedure for isolating the DMC catalysts from the suspension, by filtration, filter cake washing and drying, is described in WO-A 01/80994.

The polyethercarbonate polyols obtainable by the process according to the invention can be processed without problems, in particular by conversion with di- and/or polyisocyanates to polyurethanes, especially flexible polyurethane foams. The polyethercarbonate polyols used for polyurethane applications are preferably those based on an H-functional starter compound having a functionality of at least 2. Furthermore, the polyethercarbonate polyols obtainable by the process according to the invention can be used in applications such as detergent and cleaning agent formulations, drilling fluids, fuel additives, ionic and non-ionic surfactants, lubricants, process chemicals for paper or textile production, or cosmetic formulations.

In another preferred embodiment of the process according to the invention the DMC catalyst contains zinc hexacyanocobaltate(III), zinc hexacyanoiridate(III), zinc hexacyanoferrate(III) and/or cobalt(II) hexacyanocobaltate(III). It is further preferred that in the catalyst ligands such as alkanols and/or polyalkylene glycols are present.

The polyethercarbonate polyols obtained according to the invention preferably have an OH functionality (i.e. mean number of OH groups per molecule) of at least 0.8, preferably of 1 to 8, particularly preferably of 1 to 6 and very particularly preferably of 2 to 4. The number average molecular weight (GPC, polystyrene standards) of the polyethercarbonate polyols obtained is at least 400 g/mol, preferably 400 to 1,000,000 g/mol and particularly preferably 500 to 60,000 g/mol.

In another preferred embodiment, the process according to the invention further comprises the step of obtaining a polyethercarbonate polyol with a polydispersity index M_{w}/Mₙ, determined using gel permeation chromatography against polystyrene standards, of ≦1.22 and/or with a CO₂ content, expressed as carbonate groups in the polyol, of ≧15 weight-% to ≦25 weight-%.

The GPC method is described in DIN 55672-1: “Gel Permeation Chromatography, Part 1—Tetrahydrofuran as Eluent”. Preferably the polydispersity index is ≦1.2. Such molecular weight distributions are best achieved using a “strongly” dried DMC catalyst. It is furthermore preferred that the obtained polyols have a number average molecular weight between 3000 and 4000 g/mol (to DIN 53240-2, except that N-methylpyrrolidone instead of THF/dichloromethane as solvent).

Preferably the CO₂ content is ≧10 weight-% to ≦35 weight-% and more preferably ≧15 weight-% to ≦25 weight-%. Methods for the determination of the CO₂ content in the polyethercarbonate polyol are known. The CO₂ content can for example be determined from the ¹H -NMR spectrum as described in the examples.

Thus, in a first embodiment the invention is directed to a process for the preparation of polyethercarbonate polyols comprising the reaction of a reaction mixture comprising one or more H-functional starter compounds, one or more alkylene oxides, carbon dioxide and a double metal cyanide (DMC) catalyst, characterized in that the reaction is conducted in a reactor under stirring with a specific power input into the reaction mixture, expressed as Watts per liter (W/L), of ≧0.07 to ≦5.00, preferably ≧0.1 to ≦5.00, more preferred ≧0.25 to ≦5.0.

In a second embodiment the invention is directed to a process for the preparation of polyethercarbonate polyols comprising the reaction of a reaction mixture comprising one or more H-functional starter compounds, one or more alkylene oxides, carbon dioxide and a double metal cyanide (DMC) catalyst, wherein:
(α) the DMC catalyst, a suspending agent which comprises no H-functional groups and/or one or more H-functional starter compounds are initially introduced into the reactor,
(β) optionally, under an atmosphere of inert gas, inert gas/carbon dioxide mixture or under a carbon dioxide atmosphere, a fraction (based on the total amount of alkylene oxides used in steps (β) and (γ)) of one or more alkylene oxides is added into the reactor in one or more portions to the mixture from step (α) at temperatures of 50 to 200° C., preferably of 80 to 160° C. and particularly preferably of 125 to 135° C., and
(γ) one or more alkylene oxides, carbon dioxide and optionally one or more H-functional starter compounds are copolymerized in the reactor,
   characterized in that the copolymerisation (step (γ)) is conducted in a reactor under stirring with a specific power input into the reaction mixture, expressed as Watts per liter (W/L), of ≧0.07 to ≦5.00, preferably ≧0.1 to ≦5.00, more preferred >0.25 to <5.0 and preferably whereby the specific power input is determined after the volume of the reaction mixture in the copolymerisation step has obtained a constant value.

In a third embodiment the invention is directed to a process according to the second embodiment, wherein after step (α) an inert gas, an inert gas/carbon dioxide mixture or carbon dioxide is passed through the reaction mixture at a temperature of ≧115° C. to ≦150° C. and at the same time a reduced pressure (absolute) of 10 mbar to 800 mbar is established in the reactor by removal of the inert gas or carbon dioxide.

In a forth embodiment the invention is directed to a process according to the second embodiment, wherein after step (α) an inert gas, an inert gas/carbon dioxide mixture or carbon dioxide is passed through the reaction mixture at a temperature of ≧80° C. to <115° C., preferably ≧95° C. to ≦105° C., and at the same time a reduced pressure (absolute) of 10 mbar to 800 mbar is established in the reactor by removal of the inert gas or carbon dioxide.

In a fifth embodiment the invention is directed to a process according to the process according to one or more of the first to forth embodiment, wherein the stirring is conducted at a constant speed, preferably wherein the stirring in the copolymerisation step is conducted at a constant speed.

In a sixth embodiment the invention is directed to a process according to the process according to one or more of the first to fifth embodiment, wherein the specific power input is determined after the volume of the reaction mixture has obtained a constant value, preferably wherein the specific power input in the copolymerisation step is determined after the volume of the reaction mixture has obtained a constant value.

In a seventh embodiment the invention is directed to a process according to the process according to one or more of the first to sixth embodiment, wherein the stirring is conducted using any kind and/or combination of radial or axial flow agitator, preferably wherein the stirring in the copolymerisation step is conducted using any kind andlor combination of radial or axial flow agitator.

In a eighth embodiment the invention is directed to a process according to the process according to one or more of the first to sevenths embodiment, wherein the reaction, preferably the copolymerisation step, is carried out in:
an agitated tank reactor which optionally comprises an external loop with pump that recirculates material back into the reactor,
a tubular reactor which optionally comprises an external loop with pump that recirculates material back into the reactor, or
a loop reactor;
the reactors furthermore optionally comprising an external heat exchanger.

In a ninth embodiment the invention is directed to a process according to the process according to one or more of the first to eighth embodiment, wherein the one or more H-functional starter compounds and one or more alkylene oxides are metered continuously in the presence of carbon dioxide into the reactor, preferably wherein in the copolymerization step the one or more H-functional starter compounds and one or more alkylene oxides are metered continuously in the presence of carbon dioxide into the reactor.

In a tenth embodiment the invention is directed to a process according to the process according to one or more of the first to ninths embodiment, wherein the DMC catalyst is metered continuously into the reactor, the resulting reaction mixture comprising polyethercarbonate polyols is removed continuously from the reactor and one or more H-functional starter compounds are metered continuously into the reactor, preferably wherein in the copolymerization step the DMC catalyst is metered continuously into the reactor, and the resulting reaction mixture comprising polyethercarbonate polyols is removed continuously from the reactor.

In a eleventh embodiment the invention is directed to a process according to the process according to one or more of the first to tenth embodiment, wherein the H-functional starter compounds are selected from the group comprising monohydric alcohols, polyhydric alcohols, polybasic amines, polyhydric thiols, amino alcohols, thio alcohols, hydroxy esters, polyether polyols, polyester polyols, polyesterether polyols, polycarbonate polyols, polyethercarbonate polyols, polyethyleneimines, polyetheramines, polytetrahydrofurans, polytetrahydrofuranamines, polyetherthiols, polyacrylate polyols, castor oil, ricinoleic acid mono- or diglyceride, fatty acid monoglycerides, chemically modified fatty acid mono-, di- and/or triglycerides, and fatty acid C₁-C₂₄-alkyl esters containing an average of at least 2 OH groups per molecule.

In a twelfth embodiment the invention is directed to a process according to the process according to one or more of the first to eleventh embodiment, wherein the DMC catalyst contains zinc hexacyanocobaltate(III), zinc hexacyanoiridate(III), zinc hexacyanoferrate(III) and/or cobalt(II) hexacyanocobaltate(III).

In a thirteenth embodiment the invention is directed to a process according to the process according to one or more of the first to twelfth embodiment, further comprising the step of obtaining a polyethercarbonate polyol with a polydispersity index M_{w}/Mₙ, determined using gel permeation chromatography against polystyrene standards, of ≦1.22 and/or with a CO₂ content, expressed as carbonate groups in the polyol, of ≧15 weight-% to ≦25 weight-%.

In a fourteenth embodiment the invention is directed to a process according to the process according to one or more of the first to thirteenths embodiment, wherein the concentration of free alkylene oxides during the reaction is >0 to ≦10 weight-%, based on the total weight of the reaction mixture, preferably wherein in the copolymerization step the concentration of free alkylene oxides during the reaction is >0 to ≦10 weight-%, based on the total weight of the reaction mixture.

In a fifteenth embodiment the invention is directed to a process according to the process according to one or more of the first to fourteenth embodiment, wherein the specific power input into the reaction mixture, expressed as Watts per liter (W/L), is ≧0.25 to ≦5.0, preferably wherein the specific power input into the reaction mixture of the copolymerization step, expressed as Watts per liter (W/L), is ≧0.25 to ≦5.0 and wherein the specific power input is determined after the volume of the reaction mixture has obtained a constant value.

### EXAMPLES

The present invention will be described further with reference to the following examples without wishing to be limited by them.

H-Functional Starter Compound (Starter) Used:

PET-1: bifunctional poly(oxypropylene) polyol with an OH number of 240 mg KOH/g.

Catalyst Used:

The DMC catalyst was prepared according to example 6 of WO 01/80994 A1.

Reactor Used:

The 970 ml pressurized reactor used in the examples had a height (internal) of 13.7 cm and an internal diameter of 9.5 cm. The reactor was fitted with an electric heating jacket (1000 watt maximum heating capacity). The counter cooling consisted of a serpentine-shaped dip tube of external diameter ¼ inch which projected into the reactor to within 27 mm of the bottom and through which cooling water at approx. 10° C. was passed. The water stream was switched on and off by means of a solenoid valve. The reactor was also fitted with an inlet tube of diameter ¼ inch and a temperature probe of diameter ½ inch, both of which projected into the reactor to within 17 mm of the bottom.

During the activation [step (β)] the electric heating jacket was on average at approx. 20% of its maximum heating capacity. Due to regulation, the heating capacity varied by ±5% of the maximum value. The onset of an increased evolution of heat in the reactor caused by the rapid conversion of propylene oxide during the activation of the catalyst [step (β)] was observed in a reduction of the heating capacity of the heating jacket, the switching-on of the counter cooling and, if appropriate, a temperature rise in the reactor. The onset of an evolution of heat in the reactor caused by the continuous conversion of propylene oxide during the reaction [step (γ)] led to a lowering of the capacity of the heating jacket to approx. 8% of the maximum value. Due to regulation, the heating capacity varied by ±5% of the maximum value.

The hollow shaft agitator used in the examples was one in which the gas was introduced into the reaction mixture through a hollow shaft of the agitator. The agitating body attached to the hollow shaft had four arms of diameter 50 mm and height 18 mm. Three gas outlets of diameter 3 mm were attached to each end of the arm. As the agitator rotated, a pressure reduction was created such that the gas above the reaction mixture (CO₂ and optionally alkylene oxide) was aspirated and passed through the hollow shaft of the agitator into the reaction mixture.

Power Input:

The measurement of the power input (P) was not possible as the power losses at the gasket due to friction is higher than the actually applied power input in the reaction mixture for the used laboratory set-up. This is typical for the small laboratory scale. Therefore the specific power input P/V[Watts/liter] (short [W/L]) was calculated as follows for the reactor mentioned above. The calculation does not take into account any dispersed gas bubbles within the liquid reaction mixture. The amount of gas bubbles are difficult to predict or determine during an experiment. The specific power input calculation is based on a calibration curve determined without gasket with model liquid without gas input in the appropriate viscosity range.

For the turbulent flow range the specific power input is calculated in general with:

P/V=Ne*n³*n³*d⁵*density/V

(Ne=Newton number; n=agitator speed; d=agitator diameter (50 mm); density=950 kg/m³, V=filling volume (which is the volume of the reaction mixture at the end of the reaction)

The Newton number is a constant value in the turbulent flow range. It depends on the geometry of agitator and the internals of the stirred tank reactor such as baffles or cooling pipes. Values can be found for example in the chapter “Stirring” by M. Zlokarnik as part of Ullmann's Encyclopedia of Industrial Chemistry, 2012, Wiley-VCH Verlag Weinheim.

The flow range is characterized by the calculated Reynolds number (Re) Re=n*d²*density/viscosity. In general the turbulent flow range is characterized by high Re numbers, the laminar flow range is characterized by low Re numbers. A transitional flow range exists between both flow ranges. The numerical values for Re for separation of the flow ranges depend on the exact geometry of agitator and the internals of the stirred tank reactor such as baffles ro cooling pipes. Values can be found for example in the chapter “Stirring” by M. Zlokarnik as part of Ullmann's Encyclopedia of Industrial Chemistry, 2012, Wiley-VCH Verlag Weinheim.

In the above described laboratory set-up for the following examples the agitation resulted in the laminar and transitional flow range.

For the laminar flow range the specific power input is calculated with:

P/V=C*n²*d³*viscosity/V

In the laminar flow range the Newton number multiplied by the Reynolds number is a constant value (C).

(C=Re*Ne; Re=Reynolds number; C=0.36983*Re+1246.63301 measured during gasket free reactor set-up with model fluid with the help of torque measuring device on a rotating shaft; viscosity=0.1 Pa·s, V=610 ml−filling volume of the reactor at the end of the batch)

The following table gives the calculation results for the specific power input of the above-mentioned reactor used in the reaction examples which are outlined further below.

| N | P/V | Ne | Re | C |
|---|---|---|---|---|
| [min⁻¹] | [W/liter] | [—] | [—] | [—] |
| 50 | 0.02 | 63.36 | 19.79 | 1253.95 |
| 100 | 0.07 | 31.86 | 39.58 | 1261.27 |
| 200 | 0.29 | 16.12 | 79.17 | 1275.91 |
| 262 | 0.50 | 12.39 | 103.71 | 1284.99 |
| 448 | 1.50 | 7.40 | 177.33 | 1312.22 |
| 628 | 3.00 | 5.38 | 248.58 | 1338.57 |
| 803 | 5.00 | 4.29 | 317.85 | 1364.19 |

Analysis of the Polyethercarbonate Polyols:

In addition to the cyclic propylene carbonate, the copolymerization produced a polyethercarbonate polyol containing on the one hand polycarbonate units:

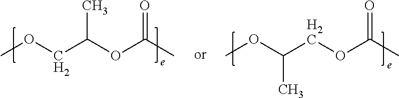

and on the other hand polyether units:

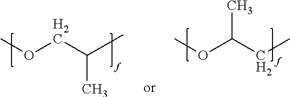

The reaction mixture was characterized by ¹H-NMR spectroscopy and gel permeation chromatography:

The ratio of the amount of cyclic propylene carbonate to polyethercarbonate polyol (selectivity), the molar ratio of carbonate groups to ether groups in the polyethercarbonate polyol (ratio e/f) and the proportion of converted propylene oxide (C in mol %) were determined by ¹H-NMR spectroscopy. Each sample was dissolved in deuterated chloroform and measured on a Bruker spectrometer (AV400, 400 MHz). The relevant resonances in the ¹H-NMR spectrum (relative to TMS=0 ppm), which were used for integration are as follows:
I1: 1.11-1.17: methyl group of polyether units; resonance area corresponds to three H atoms
I2: 1.25-1.32: methyl group of polycarbonate units; resonance area corresponds to three H atoms
I3: 1.45-1.49: methyl group of cyclic carbonate; resonance area corresponds to three H atoms
I4: 2.95-2.99: CH group of free, unreacted propylene oxide; resonance area corresponds to one H atom

The molar ratio of the amount of cyclic propylene carbonate to carbonate units in the polyethercarbonate polyol (selectivity, g/e), the CO₂-content (in weight-%) and the molar ratio of carbonate groups to ether groups in the polyethercarbonate polyol (ratio e/f) were calculated by taking the relative intensities into consideration, the values being calculated as follows:

Selectivity (g/e): molar ratio of the amount of cyclic propylene carbonate to carbonate units in the polyethercarbonate polyol

g/e=I3/I2

Selectivity (e/f): molar ratio of carbonate groups to ether groups in the polymer

e/f=I2/I1

CO₂-content (weight-%): the amount of CO₂ incorporated in the polyethercarbonate polyol

CO₂ content (weight %)=[(I2·44)/((I1·58)+(I2·102))]·100

The molar proportion of unreacted PO (UR_{PO}) in the crude product:

UR_{PO}=[(I4)/((I1/3)+(I2/3)+(I3/3)+(I4))]·100%

The number-average and weight-average molecular weights, Mₙ and M_{w}, of the polymers formed were determined by gel permeation chromatography (GPC) using the procedure according to DIN 55672-1: “Gel Permeation Chromatography, Part 1—Tetrahydrofuran as Eluent” (SECurity GPC system from PSS Polymer Service; flow rate 1.0 ml/min; columns: 2×PSS SDV linear M, 8×300 mm, 5 μm; RID detector). Polystyrene samples of known molecular weight were used for calibration.

The OH number (hydroxyl number) was determined according to DIN 53240-2, except that N-methylpyrrolidone was used instead of THF/dichloromethane as solvent. Titration was carried out with 0.5 molar ethanolic KOH solution (end point detection by potentiometry). The test substance used was castor oil of certified OH number. The recorded unit “mg KOHg⁻¹” refers to mg[KOH]/g[polyethercarbonate polyol].

The viscosity was determined on an Anton Paar Physica MCR 501 rheometer equipped with a D-CP/PP 7 (25 mm Cone-Plate) measuring system. The shear rate was increased from 0.01 to 1000 l/s in 60 increments, whereby a constant shear rate was applied for 10 seconds each. The viscosity was calculated as the average of the 60 measurements. The data measured were processed using Rheoplus version 3.40 software.

### Example 1

### Copolymerization of Propylene Oxide and CO₂ with a Strongly Dried DMC Catalyst Setting a Stirring speed of 803 rpm

[Step (α)]

A mixture of DMC catalyst (116 mg) and PET-1 (135 g) was placed in a 970 ml pressure reactor equipped with a hollow shaft agitator. The reactor was closed and the pressure inside was reduced to 5 mbar for five minutes. The reactor pressure was then regulated to 50 mbar by passing a gentle stream of Ar and simultaneously removing the gas with a pump. The reactor was heated to 130° C. and the mixture was agitated for 30 min (803 rpm) at 130° C. under reduced pressure (50 mbar) and a gentle stream of Ar.

[Step (β)]

A pressure of 50 bar of CO₂ was applied, causing the reactor temperature to fall slightly. The temperature was readjusted to 130° C. and the reactor pressure was kept at 50 bar during the subsequent steps by feeding CO₂. Subsequently, a 1^{st} portion of propylene oxide (13 g) was added into the reactor with an HPLC pump (6.5 mL/min) and the reaction mixture was stirred for 20 min (803 rpm). A further two portions (13 g each) of propylene oxide were added into the reactor with an HPLC pump (6.5 mL/min) and the reaction mixture was stirred for 20 min (803 rpm) each time.

[Step (γ)]

After cooling to 100° C., a further 301 g of propylene oxide were added with an HPLC pump (6.5 mL/min), while the CO₂ pressure was maintained at 50 bar throughout the reaction by feeding CO₂. The mixture was stirred for 2 h setting a stirring speed of 803 rpm at 100° C.

The reaction was ended by subsequently cooling the reactor with ice-cold water, the excess pressure was removed and the resulting product was analysed.

The stirring speed of 803 rpm corresponds to a specific power input of 5.0 W/L after the volume of the reaction mixture has obtained a constant value of 610 ml.

The conversion of the propylene oxide was shown to be complete by ¹H-NMR spectroscopic analysis of the reaction mixture.

| | | |
|---|---|---|
| Selectivity | g/e | 0.18 |
| | e/f | 0.39 |
| CO₂ content | weight % | 17.7 |
| Molecular weight (g/mol) | Mₙ | 3793 |
| | M_{w} | 4552 |

| | |
|---|---|
| Polydispersity index | 1.20 |
| OH number (mg KOH · g⁻¹) | 63.3 |

Example 1 was repeated two times with respect to batch to batch consistency. The following table gives an overview of the results of the series of repeated experiments:

| | Specific | | | | | | | OH no. |
|---|---|---|---|---|---|---|---|---|
| | power input | Stirring | | | CO₂ content | Mₙ | | (mg |
| Example 1 | (W/L) | (rpm) | g/e | e/f | [weight %] | (g/mol) | PDI | KOH · g⁻¹) |
| Batch 1 | 5.0 | 803 | 0.18 | 0.39 | 17.7 | 3793 | 1.20 | 63.3 |
| Batch 2 | 5.0 | 803 | 0.17 | 0.42 | 18.4 | 3792 | 1.17 | 62.7 |

### Example 2

### Copolymerization of Propylene Oxide and CO₂ with a Strongly Dried DMC Catalyst Setting a Stirring Speed of 628 rpm

[Step (α)]

A mixture of DMC catalyst (116 mg) and PET-1 (135 g) was placed in a 970 ml pressure reactor equipped with a hollow shaft agitator. The reactor was closed and the pressure inside was reduced to 5 mbar for five minutes. The reactor pressure was then regulated to 50 mbar by passing a gentle stream of Ar and simultaneously removing the gas with a pump. The reactor was heated to 130° C. and the mixture was agitated for 30 min (628 rpm) at 130° C. under reduced pressure (50 mbar) and a gentle stream of Ar.

[Step (β)]

A pressure of 50 bar of CO₂ was applied, causing the reactor temperature to fall slightly. The temperature was readjusted to 130° C. and the reactor pressure was kept at 50 bar during the subsequent steps by feeding CO₂. Subsequently, a 1^{st} portion of propylene oxide (13 g) was added into the reactor with an HPLC pump (6.5 mL/min) and the reaction mixture was stirred for 20 min (628 rpm). A further two portions (13 g each) of propylene oxide were added into the reactor with an HPLC pump (6.5 mL/min) and the reaction mixture was stirred for 20 min (628 rpm) each time.

[Step (γ)]

After cooling to 100° C., a further 301 g of propylene oxide were added with an HPLC pump (6.5 mL/min), while the CO₂ pressure was maintained at 50 bar throughout the reaction by feeding CO₂. The mixture was stored for 2 h setting a stirring speed of 628 rpm at 100° C.

The reaction was ended by subsequently cooling the reactor with ice-cold water, the excess pressure was removed and the resulting product was analysed.

The stirring speed of 628 rpm corresponds to a specific power input of 3.0 W/L after the volume of the reaction mixture has obtained a constant value of 610 ml.

The conversion of the propylene oxide was shown to be complete by ¹H-NMR spectroscopic analysis of the reaction mixture.

| | | |
|---|---|---|
| Selectivity | g/e | 0.19 |
| | e/f | 0.40 |
| CO₂ content | weight % | 17.2 |
| Molecular weight (g/mol) | Mₙ | 3297 |
| | M_{w} | 3956 |

| | |
|---|---|
| Polydispersity index | 1.20 |
| OH number (mg KOH · g⁻¹) | 63.6 |

### Example 3

### Copolymerization of Propylene Oxide and CO₂ with a Strongly Dried DMC Catalyst Setting a Stirring Speed of 448 rpm

[Step (α)]

A mixture of DMC catalyst (116 mg) and PET-1 (135 g) was placed in a 970 ml pressure reactor equipped with a hollow shaft agitator. The reactor was closed and the pressure inside was reduced to 5 mbar for five minutes. The reactor pressure was then regulated to 50 mbar by passing a gentle stream of Ar and simultaneously removing the gas with a pump. The reactor was heated to 130° C. and the mixture was agitated for 30 min (448 rpm) at 130° C. under reduced pressure (50 mbar) and a gentle stream of Ar.

[Step (β)]

A pressure of 50 bar of CO₂ was applied, causing the reactor temperature to fall slightly. The temperature was readjusted to 130° C. and the reactor pressure was kept at 50 bar during the subsequent steps by feeding CO₂. Subsequently, a 1^{st} portion of propylene oxide (13 g) was added into the reactor with an HPLC pump (6.5 mL/min) and the reaction mixture was stirred for 20 min (448 rpm). A further two portions (13 g each) of propylene oxide were added into the reactor with an HPLC pump (6.5 mL/min) and the reaction mixture was stirred for 20 min (448 rpm) each time.

[Step (γ)]

After cooling to 100° C., a further 301 g of propylene oxide were added with an HPLC pump (6.5 mL/min), while the CO₂ pressure was maintained at 50 bar throughout the reaction by feeding CO₂. The mixture was stirred for 2 h setting a stirring speed of 448 rpm at 100° C.

The reaction was ended by subsequently cooling the reactor with ice-cold water, the excess pressure was removed and the resulting product was analysed.

The stirring speed of 448 rpm corresponds to a specific power input of 1.5 W/L after the volume of the reaction mixture has obtained a constant value of 610 ml.

The conversion of the propylene oxide was shown to be complete by ¹H-NMR spectroscopic analysis of the reaction mixture.

| | | |
|---|---|---|
| Selectivity | g/e | 0.18 |
| | e/f | 0.40 |
| CO₂ content | weight % | 17.8 |
| Molecular weight (g/mol) | Mₙ | 3295 |
| | M_{w} | 3921 |

| | |
|---|---|
| Polydispersity index | 1.19 |
| OH number (mg KOH · g⁻¹) | 63.1 |

### Example 4

### Copolymerization of Propylene Oxide and CO₂ with a Strongly Dried DMC Catalyst Setting a Stirring Speed of 262 rpm

[Step (α)]

A mixture of DMC catalyst (116 mg) and PET-1 (135 g) was placed in a 970 ml pressure reactor equipped with a hollow shaft agitator. The reactor was closed and the pressure inside was reduced to 5 mbar for five minutes. The reactor pressure was then regulated to 50 mbar by passing a gentle stream of Ar and simultaneously removing the gas with a pump. The reactor was heated to 130° C. and the mixture was agitated for 30 min (262 rpm) at 130° C. under reduced pressure (50 mbar) and a gentle stream of Ar.

[Step (β)]

A pressure of 50 bar of CO₂ was applied, causing the reactor temperature to fall slightly. The temperature was readjusted to 130° C. and the reactor pressure was kept at 50 bar during the subsequent steps by feeding CO₂. Subsequently, a 1^{st} portion of propylene oxide (13 g) was added into the reactor with an HPLC pump (6.5 mL/min) and the reaction mixture was stirred for 20 min (262 rpm). A further two portions (13 g each) of propylene oxide were added into the reactor with an HPLC pump (6.5 mL/min) and the reaction mixture was stirred for 20 min (262 rpm) each time.

[Step (γ)]

After cooling to 100° C., a further 301 g of propylene oxide were added with an HPLC pump (6.5 mL/min), while the CO₂ pressure was maintained at 50 bar throughout the reaction by feeding CO₂. The mixture was stirred for 2 h setting a stirring speed of 262 rpm at 100° C.

The reaction was ended by subsequently cooling the reactor with ice-cold water, the excess pressure was removed and the resulting product was analysed.

The stirring speed of 262 rpm corresponds to a specific power input of 0.50 W/L after the volume of the reaction mixture has obtained a constant value of 610 ml.

The conversion of the propylene oxide was shown to be complete by ¹H-NMR spectroscopic analysis of the reaction mixture.

| | | |
|---|---|---|
| Selectivity | g/e | 0.17 |
| | e/f | 0.38 |
| CO₂ content | weight % | 17.4 |
| Molecular weight (g/mol) | Mₙ | 3243 |
| | M_{w} | 3924 |

| | |
|---|---|
| Polydispersity index | 1.21 |
| OH number (mg KOH · g⁻¹) | 63.0 |

### Example 5

### Copolymerization of Propylene Oxide and CO₂ with a Strongly Dried DMC Catalyst Setting a Stirring Speed of 200 rpm

[Step (α)]

A mixture of DMC catalyst (116 mg) and PET-1 (135 g) was placed in a 970 ml pressure reactor equipped with a hollow shaft agitator. The reactor was closed and the pressure inside was reduced to 5 mbar for five minutes. The reactor pressure was then regulated to 50 mbar by passing a gentle stream of Ar and simultaneously removing the gas with a pump. The reactor was heated to 130° C. and the mixture was agitated for 30 min (200 rpm) at 130° C. under reduced pressure (50 mbar) and a gentle stream of Ar.

[Step (β)]

A pressure of 50 bar of CO₂ was applied, causing the reactor temperature to fall slightly. The temperature was readjusted to 130° C. and the reactor pressure was kept at 50 bar during the subsequent steps by feeding CO₂. Subsequently, a 1^{st} portion of propylene oxide (13 g) was added into the reactor with an HPLC pump (6.5 mL/min) and the reaction mixture was stirred for 20 min (200 rpm). A further two portions (13 g each) of propylene oxide were added into the reactor with an HPLC pump (6.5 mL/min) and the reaction mixture was stirred for 20 min (200 rpm) each time.

[Step (γ)]

After cooling to 100° C., a further 301 g of propylene oxide were added with an HPLC pump (6.5 mL/min), while the CO₂ pressure was maintained at 50 bar throughout the reaction by feeding CO₂. The mixture was stirred for 2 h setting a stirring speed of 200 rpm at 100° C.

The reaction was ended by subsequently cooling the reactor with ice-cold water, the excess pressure was removed and the resulting product was analysed.

The stirring speed of 200 rpm corresponds to a specific power input of 0.29 W/L after the volume of the reaction mixture has obtained a constant value of 610 ml.

The conversion of the propylene oxide was shown to be complete by ¹H-NMR spectroscopic analysis of the reaction mixture.

| | | |
|---|---|---|
| Selectivity | g/e | 0.18 |
| | e/f | 0.38 |
| CO₂ content | weight % | 17.2 |
| Molecular weight (g/mol) | Mₙ | 3189 |
| | M_{w} | 3826 |

| | |
|---|---|
| Polydispersity index | 1.20 |
| OH number (mg KOH · g⁻¹) | 63.6 |

### Example 6

### Copolymerization of Propylene Oxide and CO₂ with a Strongly Dried DMC Catalyst Setting a Stirring Speed of 100 rpm

[Step (α)]

A mixture of DMC catalyst (116 mg) and PET-1 (135 g) was placed in a 970 ml pressure reactor equipped with a hollow shaft agitator. The reactor was closed and the pressure inside was reduced to 5 mbar for five minutes. The reactor pressure was then regulated to 50 mbar by passing a gentle stream of Ar and simultaneously removing the gas with a pump. The reactor was heated to 130° C. and the mixture was agitated for 30 min (100 rpm) at 130° C. under reduced pressure (50 mbar) and a gentle stream of Ar.

[Step (β)]

A pressure of 50 bar of CO₂ was applied, causing the reactor temperature to fall slightly. The temperature was readjusted to 130° C. and the reactor pressure was kept at 50 bar during the subsequent steps by feeding CO₂. Subsequently, a 1^{st} portion of propylene oxide (13 g) was added into the reactor with an HPLC pump (6.5 mL/min) and the reaction mixture was stirred for 20 min (100 rpm). A further two portions (13 g each) of propylene oxide were added into the reactor with an HPLC pump (6.5 mL/min) and the reaction mixture was stirred for 20 min (100 rpm) each time.

[Step (γ)]

After cooling to 100° C., a further 301 g of propylene oxide were added with an HPLC pump (6.5 mL/min), while the CO₂ pressure was maintained at 50 bar throughout the reaction by feeding CO₂. The mixture was stirred for 2 h setting a stirring speed of 100 rpm at 100° C.

The reaction was ended by subsequently cooling the reactor with ice-cold water, the excess pressure was removed and the resulting product was analysed.

The stirring speed of 100 rpm corresponds to a specific power input of 0.07 W/L after the volume of the reaction mixture has obtained a constant value of 610 ml.

The conversion of the propylene oxide was shown to be complete by ¹H-NMR spectroscopic analysis of the reaction mixture.

| | | |
|---|---|---|
| Selectivity | g/e | 0.17 |
| | e/f | 0.37 |
| CO₂ content | weight % | 17.1 |
| Molecular weight (g/mol) | Mₙ | 3113 |
| | M_{w} | 3797 |

| | |
|---|---|
| Polydispersity index | 1.22 |
| OH number (mg KOH · g⁻¹) | 63.3 |

### Comparative example 7

### Copolymerization of Propylene Oxide and CO₂ with a Strongly Dried DMC Catalyst Setting a Stirring Speed of 50 rpm

[Step (α)]

A mixture of DMC catalyst (116 mg) and PET-1 (135 g) was placed in a 970 ml pressure reactor equipped with a hollow shaft agitator. The reactor was closed and the pressure inside was reduced to 5 mbar for five minutes. The reactor pressure was then regulated to 50 mbar by passing a gentle stream of Ar and simultaneously removing the gas with a pump. The reactor was heated to 130° C. and the mixture was agitated for 30 min (50 rpm) at 130° C. under reduced pressure (50 mbar) and a gentle stream of Ar.

[Step (β)]

A pressure of 50 bar of CO₂ was applied, causing the reactor temperature to fall slightly. The temperature was readjusted to 130° C. and the reactor pressure was kept at 50 bar during the subsequent steps by feeding CO₂. Subsequently, a 1^{st} portion of propylene oxide (13 g) was added into the reactor with an HPLC pump (6.5 mL/min) and the reaction mixture was stirred for 20 min (50 rpm). A further two portions (13 g each) of propylene oxide were added into the reactor with an HPLC pump (6.5 mL/min) and the reaction mixture was stirred for 20 min (50 rpm) each time.

[Step (γ)]

After cooling to 100° C., a further 301 g of propylene oxide were added with an HPLC pump (6.5 mL/min), while the CO₂ pressure was maintained at 50 bar throughout the reaction by feeding CO₂. The mixture was stirred for 2 h setting a stirring speed of 50 rpm at 100° C.

The reaction was ended by subsequently cooling the reactor with ice-cold water, the excess pressure was removed and the resulting product was analysed.

The stirring speed of 50 rpm corresponds to a specific power input of 0.02 W/L after the volume of the reaction mixture has obtained a constant value of 610 ml.

The conversion of the propylene oxide was shown to be complete by ¹H-NMR spectroscopic analysis of the reaction mixture.

| | | |
|---|---|---|
| Selectivity | g/e | 0.27 |
| | e/f | 0.38 |
| CO₂ content | weight % | 17.2 |
| Molecular weight (g/mol) | Mₙ | 3043 |
| | M_{w} | 4412 |

| | |
|---|---|
| Polydispersity index | 1.45 |
| OH number (mg KOH · g⁻¹) | 69.1 |

Comparison

The following table gives an overview of the results of examples 1 to 7:

| | Specific | | | | | | | OH no. |
|---|---|---|---|---|---|---|---|---|
| | power input | Stirring | | | CO₂ content | Mₙ | | (mg |
| Example | (W/L) | (rpm) | g/e | e/f | [weight %] | (g/mol) | PDI | KOH · g⁻¹) |
| 1 | 5.0 | 803 | 0.18 | 0.39 | 17.7 | 3793 | 1.20 | 63.3 |
| 2 | 3.0 | 628 | 0.19 | 0.40 | 17.2 | 3297 | 1.20 | 63.6 |
| 3 | 1.5 | 448 | 0.18 | 0.40 | 17.8 | 3295 | 1.19 | 63.1 |
| 4 | 0.5 | 262 | 0.17 | 0.38 | 17.4 | 3243 | 1.21 | 63.0 |
| 5 | 0.29 | 200 | 0.18 | 0.38 | 17.2 | 3189 | 1.20 | 63.6 |
| 6 | 0.07 | 100 | 0.17 | 0.37 | 17.1 | 3113 | 1.22 | 63.3 |
| 7 (Comp.) | 0.02 | 50 | 0.27 | 0.38 | 17.2 | 3043 | 1.45 | 69.1 |

Comp.: Comparative Example

The ratio g/e is a measure of the selectivity of cyclic carbonate formation to the carbonate units in linear polyethercarbonate polyols: the smaller the value of this ratio, the lower the proportion of cyclic carbonate formed during the reaction. A comparison of examples 1-6 with comparative example 7 shows that the polyethercarbonate polyol was obtained in high selectivity, when the reaction was performed with a specific power input in the range from 0.07 to 5.0 W/L. Similarly, a comparison of example 1-6 with comparative example 7 shows that the polyethercarbonate polyol was obtained with a narrow polydispersity index when the reaction (copolymerization) was performed with a specific power input in the range from 0.07 to 5.0 W/L after the volume of the reaction mixture has obtained a constant value of 610 ml.

### Example 8

### Copolymerization of Propylene Oxide and CO₂ with a Weakly Dried DMC Catalyst Setting a Stirring Speed of 803 rpm

[Step (α)]

A mixture of DMC catalyst (116 mg) and PET-1 (135 g) was placed in a 970 ml pressure reactor equipped with a hollow shaft agitator. The reactor was closed and the pressure inside was reduced to 5 mbar for five minutes. The reactor pressure was then regulated to 50 mbar by passing a gentle stream of Ar and simultaneously removing the gas with a pump. The reactor was heated to 100° C. and the mixture was agitated for 30 min (803 rpm) at 100° C. under reduced pressure (50 mbar) and a gentle stream of Ar.

[Step (β)]

A pressure of 50 bar of CO₂ was applied, causing the reactor temperature to fall slightly. The temperature was readjusted to 130° C. and the reactor pressure was kept at 50 bar during the subsequent steps by feeding CO₂. Subsequently, a 1^{st} portion of propylene oxide (13 g) was added into the reactor with an HPLC pump (6.5 mL/min) and the reaction mixture was stirred for 20 min (803 rpm). A further two portions (13 g each) of propylene oxide were added into the reactor with an HPLC pump (6.5 mL/min) and the reaction mixture was stirred for 20 min (803 rpm) each time.

[Step (γ)]

After cooling to 100° C., a further 301 g of propylene oxide were added with an HPLC pump (6.5 mL/min), while the CO₂ pressure was maintained at 50 bar throughout the reaction by feeding CO₂. The mixture was stirred for 2 h setting a stirring speed of 803 rpm at 100° C.

The reaction was ended by subsequently cooling the reactor with ice-cold water, the excess pressure was removed and the resulting product was analysed.

The stirring speed of 803 rpm corresponds to a specific power input of 5.0 W/L after the volume of the reaction mixture has obtained a constant value of 610 ml.

The conversion of the propylene oxide was shown to be complete by ¹H-NMR spectroscopic analysis of the reaction mixture.

| | | |
|---|---|---|
| Selectivity | g/e | 0.12 |
| | e/f | 0.40 |
| CO₂ content | weight % | 18.0 |
| Molecular weight (g/mol) | Mₙ | 3276 |
| | M_{w} | 4226 |

| | |
|---|---|
| Polydispersity index | 1.29 |
| OH number (mg KOH · g⁻¹) | 59.9 |

### Example 9

### Copolymerization of Propylene Oxide and CO₂ with a Weakly Dried DMC Catalyst Setting a Stirring Speed of 628 rpm

[Step (α)]

A mixture of DMC catalyst (116 mg) and PET-1 (135 g) was placed in a 970 ml pressure reactor equipped with a hollow shaft agitator. The reactor was closed and the pressure inside was reduced to 5 mbar for five minutes. The reactor pressure was then regulated to 50 mbar by passing a gentle stream of Ar and simultaneously removing the gas with a pump. The reactor was heated to 100° C. and the mixture was agitated for 30 min (628 rpm) at 100° C. under reduced pressure (50 mbar) and a gentle stream of Ar.

[Step (β)]

A pressure of 50 bar of CO₂ was applied, causing the reactor temperature to fall slightly. The temperature was readjusted to 130° C. and the reactor pressure was kept at 50 bar during the subsequent steps by feeding CO₂. Subsequently, a 1^{st} portion of propylene oxide (13 g) was added into the reactor with an HPLC pump (6.5 mL/min) and the reaction mixture was stirred for 20 min (628 rpm). A further two portions (13 g each) of propylene oxide were added into the reactor with an HPLC pump (6.5 mL/min) and the reaction mixture was stirred for 20 min (628 rpm) each time.

[Step (γ)]

After cooling to 100° C., a further 301 g of propylene oxide were added with an HPLC pump (6.5 mL/min), while the CO₂ pressure was maintained at 50 bar throughout the reaction by feeding CO₂. The mixture was stirred for 2 h setting a stirring speed of 628 rpm at 100° C.

The reaction was ended by subsequently cooling the reactor with ice-cold water, the excess pressure was removed and the resulting product was analysed.

The storing speed of 628 rpm corresponds to a specific power input of 3.0 W/L after the volume of the reaction mixture has obtained a constant value of 610 ml.

The conversion of the propylene oxide was shown to be complete by ¹H-NMR spectroscopic analysis of the reaction mixture.

| | | |
|---|---|---|
| Selectivity | g/e | 0.12 |
| | e/f | 0.44 |
| CO₂ content | weight % | 18.7 |
| Molecular weight (g/mol) | Mₙ | 3705 |
| | M_{w} | 4631 |

| | |
|---|---|
| Polydispersity index | 1.25 |
| OH number (mg KOH · g⁻¹) | 58.9 |

### Example 10

### Copolymerization of Propylene Oxide and CO₂ with a Weakly Dried DMC Catalyst Setting a Stirring Speed of 448 rpm

[Step (α)]

A mixture of DMC catalyst (116 mg) and PET-1 (135 g) was placed in a 970 ml pressure reactor equipped with a hollow shaft agitator. The reactor was closed and the pressure inside was reduced to 5 mbar for five minutes. The reactor pressure was then regulated to 50 mbar by passing a gentle stream of Ar and simultaneously removing the gas with a pump. The reactor was heated to 100° C. and the mixture was agitated for 30 min (448 rpm) at 100° C. under reduced pressure (50 mbar) and a gentle stream of Ar.

[Step (β)]

A pressure of 50 bar of CO₂ was applied, causing the reactor temperature to fall slightly. The temperature was readjusted to 130° C. and the reactor pressure was kept at 50 bar during the subsequent steps by feeding CO₂. Subsequently, a 1^{st} portion of propylene oxide (13 g) was added into the reactor with an HPLC pump (6.5 mL/min) and the reaction mixture was stirred for 20 min (448 rpm). A further two portions (13 g each) of propylene oxide were added into the reactor with an HPLC pump (6.5 mL/min) and the reaction mixture was stirred for 20 min (448 rpm) each time.

[Step (γ)]

After cooling to 100° C., a further 301 g of propylene oxide were added with an HPLC pump (6.5 mL/min), while the CO₂ pressure was maintained at 50 bar throughout the reaction by feeding CO₂. The mixture was stirred for 2 h setting a stirring speed of 448 rpm at 100° C.

The reaction was ended by subsequently cooling the reactor with ice-cold water, the excess pressure was removed and the resulting product was analysed.

The stirring speed of 448 rpm corresponds to a specific power input of 1.5 W/L after the volume of the reaction mixture has obtained a constant value of 610 ml.

The conversion of the propylene oxide was shown to be complete by ¹H-NMR spectroscopic analysis of the reaction mixture.

| | | |
|---|---|---|
| Selectivity | g/e | 0.08 |
| | e/f | 0.44 |
| CO₂ content | weight % | 18.9 |
| Molecular weight (g/mol) | Mₙ | 3470 |
| | M_{w} | 4580 |

| | |
|---|---|
| Polydispersity index | 1.32 |
| OH number (mg KOH · g⁻¹) | 56.9 |

### Example 11

### Copolymerization of Propylene Oxide and CO₂ with a Weakly Dried DMC Catalyst Setting a Stirring Speed of 262 rpm

[Step (α)]

A mixture of DMC catalyst (116 mg) and PET-1 (135 g) was placed in a 970 ml pressure reactor equipped with a hollow shaft agitator. The reactor was closed and the pressure inside was reduced to 5 mbar for five minutes. The reactor pressure was then regulated to 50 mbar by passing a gentle stream of Ar and simultaneously removing the gas with a pump. The reactor was heated to 100° C. and the mixture was agitated for 30 min (262 rpm) at 100° C. under reduced pressure (50 mbar) and a gentle stream of Ar.

[Step (β)]

A pressure of 50 bar of CO₂ was applied, causing the reactor temperature to fall slightly. The temperature was readjusted to 130° C. and the reactor pressure was kept at 50 bar during the subsequent steps by feeding CO₂. Subsequently, a 1^{st} portion of propylene oxide (13 g) was added into the reactor with an HPLC pump (6.5 mL/min) and the reaction mixture was stirred for 20 min (262 rpm). A further two portions (13 g each) of propylene oxide were added into the reactor with an HPLC pump (6.5 mL/min) and the reaction mixture was stirred for 20 min (262 rpm) each time.

[Step (γ)]

After cooling to 100° C., a further 301 g of propylene oxide were added with an HPLC pump (6.5 mL/min), while the CO₂ pressure was maintained at 50 bar throughout the reaction by feeding CO₂. The mixture was stirred for 2 h setting a stirring speed of 262 rpm at 100° C.

The reaction was ended by subsequently cooling the reactor with ice-cold water, the excess pressure was removed and the resulting product was analysed.

The storing speed of 262 rpm corresponds to a specific power input of 0.5 W/L after the volume of the reaction mixture has obtained a constant value of 610 ml.

The conversion of the propylene oxide was shown to be complete by ¹H-NMR spectroscopic analysis of the reaction mixture.

| | | |
|---|---|---|
| Selectivity | g/e | 0.12 |
| | e/f | 0.39 |
| CO₂ content | weight % | 17.7 |
| Molecular weight (g/mol) | Mₙ | 4518 |
| | M_{w} | 6415 |

| | |
|---|---|
| Polydispersity index | 1.42 |
| OH number (mg KOH · g⁻¹) | 60.1 |

### Example 12

### Copolymerization of Propylene Oxide and CO₂ with a Weakly Dried DMC Catalyst Setting a Stirring Speed of 200 rpm

[Step (α)]

A mixture of DMC catalyst (116 mg) and PET-1 (135 g) was placed in a 970 ml pressure reactor equipped with a hollow shaft agitator. The reactor was closed and the pressure inside was reduced to 5 mbar for five minutes. The reactor pressure was then regulated to 50 mbar by passing a gentle stream of Ar and simultaneously removing the gas with a pump. The reactor was heated to 100° C. and the mixture was agitated for 30 min (200 rpm) at 100° C. under reduced pressure (50 mbar) and a gentle stream of Ar.

[Step (β)]

A pressure of 50 bar of CO₂ was applied, causing the reactor temperature to fall slightly. The temperature was readjusted to 130° C. and the reactor pressure was kept at 50 bar during the subsequent steps by feeding CO₂. Subsequently, a 1^{st} portion of propylene oxide (13 g) was added into the reactor with an HPLC pump (6.5 mL/min) and the reaction mixture was stirred for 20 min (200 rpm). A further two portions (13 g each) of propylene oxide were added into the reactor with an HPLC pump (6.5 mL/min) and the reaction mixture was stirred for 20 min (200 rpm) each time.

[Step (γ)]

After cooling to 100° C., a further 301 g of propylene oxide were added with an HPLC pump (6.5 mL/min), while the CO₂ pressure was maintained at 50 bar throughout the reaction by feeding CO₂. The mixture was stirred for 2 h setting a stirring speed of 200 rpm at 100° C.

The reaction was ended by subsequently cooling the reactor with ice-cold water, the excess pressure was removed and the resulting product was analysed.

The stirring speed of 200 rpm corresponds to a specific power input of 0.29 W/L after the volume of the reaction mixture has obtained a constant value of 610 ml.

The conversion of the propylene oxide was shown to be complete by ¹H-NMR spectroscopic analysis of the reaction mixture.

| | | |
|---|---|---|
| Selectivity | g/e | 0.10 |
| | e/f | 0.41 |
| CO₂ content | weight % | 18.0 |
| Molecular weight (g/mol) | Mₙ | 4114 |
| | M_{w} | 6047 |

| | |
|---|---|
| Polydispersity index | 1.47 |
| OH number (mg KOH · g⁻¹) | 58.6 |

### Example 13

### Copolymerization of Propylene Oxide and CO₂ with a Weakly Dried DMC Catalyst Setting a Stirring Speed of 100 rpm

[Step (α)]

A mixture of DMC catalyst (116 mg) and PET-1 (135 g) was placed in a 970 ml pressure reactor equipped with a hollow shaft agitator. The reactor was closed and the pressure inside was reduced to 5 mbar for five minutes. The reactor pressure was then regulated to 50 mbar by passing a gentle stream of Ar and simultaneously removing the gas with a pump. The reactor was heated to 100° C. and the mixture was agitated for 30 min (100 rpm) at 100° C. under reduced pressure (50 mbar) and a gentle stream of Ar.

[Step (β)]

A pressure of 50 bar of CO₂ was applied, causing the reactor temperature to fall slightly. The temperature was readjusted to 130° C. and the reactor pressure was kept at 50 bar during the subsequent steps by feeding CO₂. Subsequently, a 1^{st} portion of propylene oxide (13 g) was added into the reactor with an HPLC pump (6.5 mL/min) and the reaction mixture was stirred for 20 min (100 rpm). A further two portions (13 g each) of propylene oxide were added into the reactor with an HPLC pump (6.5 mL/min) and the reaction mixture was stirred for 20 min (100 rpm) each time.

[Step (γ)]

After cooling to 100° C., a further 301 g of propylene oxide were added with an HPLC pump (6.5 mL/min), while the CO₂ pressure was maintained at 50 bar throughout the reaction by feeding CO₂. The mixture was stirred for 2 h setting a stirring speed of 100 rpm at 100° C.

The reaction was ended by subsequently cooling the reactor with ice-cold water, the excess pressure was removed and the resulting product was analysed.

The stirring speed of 100 rpm corresponds to a specific power input of 0.07 W/L after the volume of the reaction mixture has obtained a constant value of 610 ml.

The molar proportion of unreacted PO (UR_{PO}) in the crude product was 4.81 mol %.

| | | |
|---|---|---|
| Selectivity | g/e | 0.14 |
| | e/f | 0.23 |
| CO₂ content | weight % | 12.4 |
| Molecular weight (g/mol) | Mₙ | 3075 |
| | M_{w} | 4643 |

| | |
|---|---|
| Polydispersity index | 1.51 |
| OH number (mg KOH · g⁻¹) | 68.7 |

### Comparative Example 14

### Copolymerization of Propylene Oxide and CO₂ with a Weakly Dried DMC Catalyst Setting a Stirring Speed of 50 rpm

[Step (α)]

A mixture of DMC catalyst (116 mg) and PET-1 (135 g) was placed in a 970 ml pressure reactor equipped with a hollow shaft agitator. The reactor was closed and the pressure inside was reduced to 5 mbar for five minutes. The reactor pressure was then regulated to 50 mbar by passing a gentle stream of Ar and simultaneously removing the gas with a pump. The reactor was heated to 100° C. and the mixture was agitated for 30 min (50 rpm) at 100° C. under reduced pressure (50 mbar) and a gentle stream of Ar.

[Step (β)]

A pressure of 50 bar of CO₂ was applied, causing the reactor temperature to fall slightly. The temperature was readjusted to 130° C. and the reactor pressure was kept at 50 bar during the subsequent steps by feeding CO₂. Subsequently, a 1^{st} portion of propylene oxide (13 g) was added into the reactor with an HPLC pump (6.5 mL/min) and the reaction mixture was stirred for 20 min (50 rpm). A further two portions (13 g each) of propylene oxide were added into the reactor with an HPLC pump (6.5 mL/min) and the reaction mixture was stirred for 20 min (50 rpm) each time.

[Step (γ)]

After cooling to 100° C., a further 301 g of propylene oxide were added with an HPLC pump (6.5 mL/min), while the CO₂ pressure was maintained at 50 bar throughout the reaction by feeding CO₂. The mixture was stirred for 2 h setting a stirring speed of 50 rpm at 100° C.

The reaction was ended by subsequently cooling the reactor with ice-cold water, the excess pressure was removed and the resulting product was analysed.

The stirring speed of 50 rpm corresponds to a specific power input of 0.02 W/L after the volume of the reaction mixture has obtained a constant value of 610 ml.

The molar proportion of unreacted PO (UR_{PO}) in the crude product was 2.87 mol %.

| | | |
|---|---|---|
| Selectivity | g/e | 0.54 |
| | e/f | 0.07 |
| CO₂ content | weight % | 5.0 |
| Molecular weight (g/mol) | Mₙ | 2136 |
| | M_{w} | 3887 |

| | |
|---|---|
| Polydispersity index | 1.82 |
| OH number (mg KOH · g⁻¹) | 109.6 |

Comparison

The following table gives an overview of the results of examples 8 to 14:

| | Specific | | | | | | | OH No. |
|---|---|---|---|---|---|---|---|---|
| | power input | Stirring rate | | | CO₂ content | Mₙ | | (mg |
| Example | (W/L) | (rpm) | g/e | e/f | (weight %) | (g/mol) | PDI | KOH · g⁻¹) |
| 8 | 5.0 | 803 | 0.12 | 0.40 | 18.0 | 3276 | 1.29 | 59.9 |
| 9 | 3.0 | 628 | 0.12 | 0.44 | 18.7 | 3705 | 1.25 | 58.9 |
| 10 | 1.5 | 448 | 0.08 | 0.44 | 18.9 | 3470 | 1.32 | 56.9 |
| 11 | 0.5 | 262 | 0.12 | 0.39 | 17.7 | 4518 | 1.42 | 60.1 |
| 12 | 0.29 | 200 | 0.10 | 0.41 | 18.0 | 4114 | 1.47 | 58.6 |
| 13 | 0.07 | 100 | 0.14 | 0.23 | 12.4 | 3075 | 1.51 | 68.7 |
| 14 (Comp.) | 0.02 | 50 | 0.54 | 0.07 | 5.0 | 2136 | 1.82 | 109.6 |

Comp.: Comparative Example

The ratio g/e is a measure of the selectivity of cyclic carbonate formation to the carbonate units in linear polyethercarbonate polyols: the smaller the value of this ratio, the lower the proportion of cyclic carbonate formed during the reaction. A comparison of examples 8-13 with comparative example 14 shows that the polyethercarbonate polyol was obtained in high selectivity, when the reaction was performed with a specific power input in the range from 0.07 to 5.0 W/L. Similarly, a comparison of examples 8-13 with comparative example 14 shows that the polyethercarbonate polyol was obtained with a narrow polydispersity index, when the reaction (copolymerization) was performed with a specific power input in the range from 0.07 to 5.0 W/L after the volume of the reaction mixture has obtained a constant value.

Comparison of examples 8 to 12 with examples 1 to 5 shows that a weakly dried DMC catalyst provides a higher selectivity to the polyethercarbonate polyol (lower value of ratio g/e) and a higher CO₂ content in the polyethercarbonate polyol (higher value of ratio e/f).

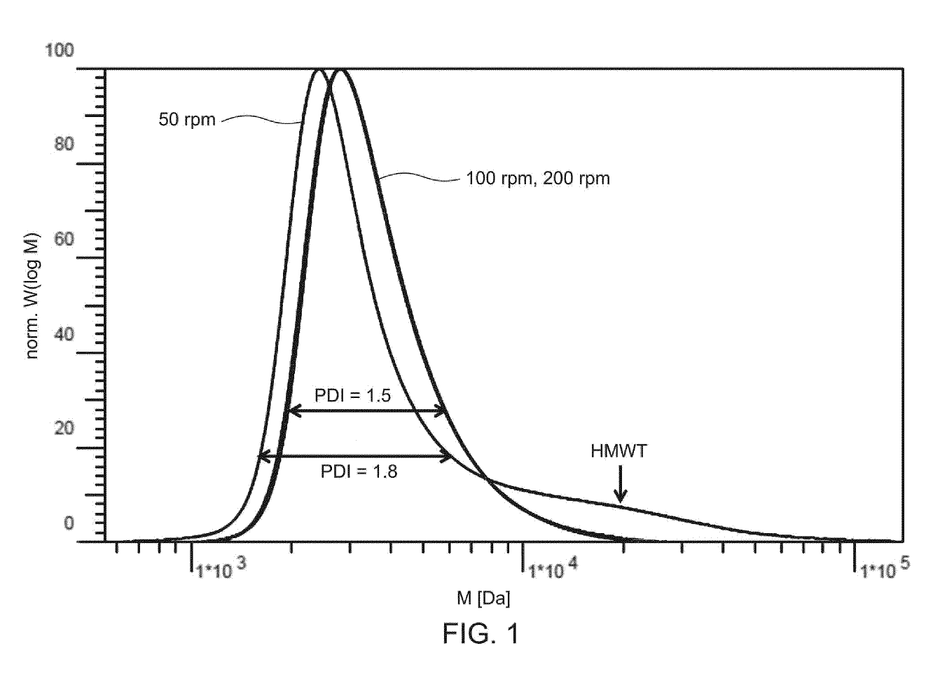

Another comparison between the results of examples 12, 13 and 14 is shown in the molecular weight distributions of FIG. 1. Examples 12 (200 rpm) and 13 (100 rpm) exhibit essentially the same distribution with a polydispersity index of ca. 1.5, whereas the curve corresponding to comparative example 14 (50 rpm) documents a polydispersity index of ca. 1.8. Furthermore a so-called high molecular weight tail (HMWT) is present in the sample according to the comparative example. This HMWT is consisting of high molecular weight polyethercarbonate portions present in the sample. These high molecular portions are undesired because they impair the final product properties (e.g. by increasing product viscosity) and are suspected to unfavourably affect processing of the polyethercarbonate polyols to polyurethane materials(e.g. polyurethane flexible foams).

1. A process for the preparation of polyethercarbonate polyols comprising the reaction of a reaction mixture comprising one or more H-functional starter compounds, one or more alkylene oxides, carbon dioxide and a double metal cyanide (DMC) catalyst, wherein:
the reaction is conducted in a reactor under stirring with a specific power input into the reaction mixture, expressed as Watts per liter (W/L), of ≧0.07 to ≦5.00; wherein the specific power input (P/V) is calculated by:
a) for the turbulent flow range the specific power input is calculated with:
P/V=Ne*n³*d⁵*density/V;
wherein Ne=Newton number of the reactor; n=agitator speed; d=agitator diameter; density of the reaction mixture, and V=filling volume (which is the volume of the reaction mixture at the end of the reaction); and
b) for the laminar flow range the specific power input is calculated with:
P/V=C*n²*d³*viscosity/V;
wherein C=Re*Ne and Re=Reynolds number of the agitator used for mixing the reaction mixture, and Ne is the Newton number of the reactor.

2. A process for the preparation of polyethercarbonate polyols comprising the reaction of a reaction mixture comprising one or more H-functional starter compounds, one or more alkylene oxides, carbon dioxide and a double metal cyanide (DMC) catalyst, wherein:
(α) the DMC catalyst, a suspending agent which comprises no H-functional groups and/or one or more H-functional starter compounds are initially introduced into the reactor;
(γ) one or more alkylene oxides, carbon dioxide and optionally one or more H-functional starter compounds are copolymerized in the reactor; and
(β) optionally, the reaction is conducted under an atmosphere of inert gas, inert gas/carbon dioxide mixture or under a carbon dioxide atmosphere, a fraction (based on the total amount of alkylene oxides used in steps (β) and (γ)) of one or more alkylene oxides is added into the reactor in one or more portions to the mixture from step (a) at temperatures of 50 to 200° C., wherein:
the copolymerisation (step (γ)) is conducted in a reactor under stirring with a specific power input into the reaction mixture, expressed as Watts per liter (W/L), of ≧0.07 to ≦5.00 wherein the specific power input (P/V) is calculated by:
a) for the turbulent flow range the specific power input is calculated with:
P/V=Ne*n³*d⁵*density/V;
wherein Ne=Newton number of the reactor; n=agitator speed; d=agitator diameter; density is the density of the reaction mixture at the end of the reaction, and V=filling volume (which is the volume of the reaction mixture at the end of the reaction); and
b) for the laminar flow range the specific power input is calculated with:
P/V=C*n²*d³*viscosity/V;
wherein C=Re*Ne and Re=Reynolds number of the agitator used for mixing the reaction mixture, and Ne is the Newton number of the reactor.

3. The process according to claim 2, wherein step (α) comprises:
(α1) placing the H-functional starter compound or a mixture of at least two H-functional starter compounds in the reactor; and
(α2) passing an inert gas, an inert gas/carbon dioxide mixture or carbon dioxide into the resulting mixture of DMC catalyst and one or more H-functional starter compounds at a temperature of 50 to 200° C. and at the same time establishing a reduced pressure (absolute) of 1000 Pa (10 mbar) to 80000 Pa (800 mbar) in the reactor by removal of the inert gas or carbon dioxide.

4. The process according to claim 2, wherein step (α) comprises:
(α1) placing the H-functional starter compound or a mixture of at least two H-functional starter compounds in the reactor under an inert gas atmosphere, under an atmosphere of inert gas/carbon dioxide mixture or under a pure carbon dioxide atmosphere; and
(α2) passing an inert gas, an inert gas/carbon dioxide mixture or carbon dioxide into the resulting mixture of DMC catalyst and one or more H-functional starter compounds at a temperature of 80 to 160° C., and at the same time establishing a reduced pressure (absolute) of 4000 Pa (40 mbar) to 20000 Pa (200 mbar), in the reactor by removal of the inert gas or carbon dioxide;
the double metal cyanide catalyst being added before or after the H-functional starter substance or the mixture of at least two H-functional starter substances.

5. The process according to claim 1, wherein the stirring is conducted at a constant speed.

6. The process according to claim 1, wherein the specific power input is determined after the volume of the reaction mixture has obtained a constant value.

7. The process according to claim 1, wherein the stirring is conducted using any kind and/or combination of radial or axial flow agitator.

8. The process according to claim 1, wherein the reaction is carried out in:
an agitated tank reactor which optionally comprises an external loop with pump that recirculates material back into the reactor;
a tubular reactor which optionally comprises an external loop with pump that recirculates material back into the reactor; or
a loop reactor;
the reactors furthermore optionally comprising an external heat exchanger.

9. The process according to claim 1, wherein the one or more H-functional starter compounds and one or more alkylene oxides are metered continuously in the presence of carbon dioxide into the reactor.

10. The process according to claim 1, wherein the DMC catalyst is metered continuously into the reactor, the resulting reaction mixture comprising polyethercarbonate polyols is removed continuously from the reactor and one or more H-functional starter compounds are metered continuously into the reactor.

11. The process according to claim 1, wherein the H-functional starter compounds are selected from the group comprising: monohydric alcohols, polyhydric alcohols, polybasic amines, polyhydric thiols, amino alcohols, thio alcohols, hydroxy esters, polyether polyols, polyester polyols, polyesterether polyols, polycarbonate polyols, polyethercarbonate polyols, polyethyleneimines, polyetheramines, polytetrahydrofurans, polytetrahydrofuranamines, polyetherthiols, polyacrylate polyols, castor oil, ricinoleic acid mono- or diglyceride, fatty acid monoglycerides, chemically modified fatty acid monoglycerides, chemically modified fatty acid diglycerides, chemically modified fatty acid triglycerides, fatty acid C₁-C₂₄-alkyl esters containing an average of at least 2 OH groups per molecule, and combinations of any thereof.

12. The process according to claim 1, wherein the DMC catalyst contains zinc hexacyanocobaltate(III), zinc hexacyanoiridate(III), zinc hexacyanoferrate(III) and/or cobalt(II) hexacyanocobaltate(III).

13. The process according to claim 1, further comprising:
obtaining a polyethercarbonate polyol with a polydispersity index M_{w}/Mₙ, determined using gel permeation chromatography against polystyrene standards, of ≦1.22 and/or with a CO₂ content, expressed as carbonate groups in the polyol, of ≧15 weight-% to ≦25 weight-%, based on the total weight of the polyol.

14. The process according to claim 1, wherein the concentration of free alkylene oxides during the reaction is >0 to ≦10 weight-%, based on the total weight of the reaction mixture.

15. The process according to claim 1, wherein the specific power input into the reaction mixture, expressed as Watts per liter (W/L), is ≧0.25 to ≦5.0.
